(19) United States
(12) Patent Application Publication
(10) Pub. No.: US 2025/0034318 A1
(43) Pub. Date: Jan. 30, 2025

(54) DISPERSANT

(71) Applicant: BASF COATINGS GMBH, Muenster (DE)

(72) Inventors: Chintankumar Jayantilal PATEL, Ludwigshafen (DE); Karel HARTLIEB, Southfield, MI (US); Holly Marie BLONDIN, Southfield, MI (US)

(21) Appl. No.: 18/712,947

(22) PCT Filed: Dec. 22, 2022
(86) PCT No.: PCT/EP22/87520

§ 371 Date: May 23, 2024

(30) Foreign Application Priority Data
Dec. 28, 2021 (EP) 21217914.7

(51) Int. Cl. C08G 59/32; C08G 59/50; C08K 3/013

(52) U.S. Cl. CPC C08G 59/3218; C08G 59/5073; C08K 3/013

(57) ABSTRACT

Disclosed herein is a polymer (D) obtained by reacting a) at least one epoxide (E) having an average functionality of ≥3.0 and a number average molar weight in a range of from 250 to 25000 g/mol as determined according to GPC using THE as solvent; b) at least one compound (P) having at least one pigment affinic group, where the pigment affinic group has at least one active hydrogen reactive to an epoxide group; and c) at least one compound(S) having at least one poly alkyleneoxide chain, where the compound(S) having at least one active hydrogen reactive to an epoxide group. Further disclosed herein is a method of using the polymer (D) as an aqueous dispersant for pigments.

### FIELD OF THE INVENTION

Presently claimed invention is directed to a polymer (D) obtained by reacting a) at least one epoxide (E) having an average functionality of ≥3.0 and a number average molar weight in the range of from 250 to 25000 g/mol as determined according to GPC using THE as solvent; b) at least one compound (P) having at least one pigment affinic group, wherein the pigment affinic group has at least one active hydrogen reactive to an epoxide group; and c) at least one compound(S) having at least one poly alkyleneoxide chain, wherein the compound(S) having at least one active hydrogen reactive to an epoxide group. The invention further discloses that use of polymer (D) as an aqueous dispersant for pigments.

### BACKGROUND OF THE INVENTION

Pigmented coating compositions are widely used as corrosion resistant primers and decorative topcoats in automotive industry. The automotive market is trending toward high transparency colour and rich chroma as colour is a major factor in the vehicle-commercialization segment of the automotive industry. The high transparency and the rich chroma is generally achieved by stable fine dispersions of organic pigment to the submicron size in the basecoat and clear coat. But the agglomeration of the pigment particles of small size, i.e. below 100 nm, during their application in coating and in long term storage in the coating composition is a major challenge in the coating industry. It is desirable that the pigment dispersions remain substantially stable in their finely dispersed form with minimal pigment stalling and viscosity change.

Generally, random copolymers are used as dispersants in pigment dispersion compositions. These copolymers contain multiple anchoring and stabilizing segments. However, their application as dispersants do not provide adequate stabilization, especially when the pigment particle size is very small. Further, hyperdispersants available in the market, for stabilizing finely dispersed organic pigment, have controlled architectures derived from special controlled polymerization technologies, which has several limitations such as a specific manufacturing set-up and stringent process conditions for their synthesis. Therefore, there is a need for continued development of pigment dispersants which can be manufactured in conventional simple polymerization set-ups with relatively robust processing conditions and still perform on par or better compared to hyperdispersants prepared by controlled polymerization techniques.

U.S. 2016/257774 A1 describes a polymeric dispersant composition comprising an acrylic backbone with at least one pendantly attached imide group, wherein the carbonyl of the imide is chemically bonded to a fused aromatic ring.

U.S. Pat. No. 6,037,414 A describes a polymeric pigment dispersant comprising a graft polymer having an acrylic backbone, polyester side chains, cyclic imide groups and quaternary ammonium groups. U.S. Pat. No. 8,129,466 B2 describes a nanoparticle dispersion comprising a dispersant comprising a triblock polymer having a first block comprising a glycidyl (meth)acrylate reacted with a naphthoic acid, a second block comprising (meth)acrylic acid alkyl esters, and a third block comprising (meth)acrylic acid alkyl esters, wherein said third block is different from said second block.

U.S. Pat. No. 7,723,425 B2 describes a composition containing modified block copolymer dispersants prepared by atom transfer radical polymerisation (ATRP) and modified with a salt forming group. The salt forming group is selected from specific monocyclic sulphonic acids or polycyclic sulphonic acids or mono- or polycyclic carboxylic and phosphonic acids, or alkyl halogenide containing monocyclic or polycyclic groups or esters of monocyclic or polycyclic sulphonic acids.

The methods and compositions disclosed in the prior arts have limitations. The compositions in the prior arts as described above do not provide efficient pigment dispersants that provide effective de-agglomeration and strong interaction with the pigment particles to achieve a fine dispersion of the pigment particles to the submicron size. The absence of a strong interaction with the pigment particles affects the transparency and colour which is desired in the market. Since, the demand for niche colour spaces with high saturation is increasing in the coating market, there is a need for the synthesis of novel dispersions for pigment that overcome the above-mentioned drawbacks and are especially able to provide more stable pigment dispersion having submicron particle size.

Thus, it an object of the presently claimed invention to provide a polymer which can function as dispersant for pigments, especially for organic pigments and provide pigment dispersion with submicron particle size.

### SUMMARY OF THE INVENTION

Surprisingly, it has been found that polymer (D) obtained by reacting:
a. at least one epoxide (E) having an average functionality of ≥3.0 and a number average molar weight in the range of from 250 to 25000 g/mol as determined according to GPC using THE as solvent;
b. at least one compound (P) having at least one pigment affinic group, wherein the pigment affinic group has at least one active hydrogen reactive to an epoxide group; and
c. at least one compound(S) has at least one polyalkylene oxide unit and at least one active hydrogen reactive to epoxide group, can provide function as dispersants with the desired properties.

Thus, in a first aspect, the presently claimed invention is directed to a polymer (D) obtained by reacting:
a. at least one epoxide (E) having an average functionality of ≥3.0 and a number average molar weight in the range of from 250 to 25000 g/mol as determined according to GPC using THE as solvent;
b. at least one compound (P) having at least one pigment affinic group, wherein the pigment affinic group has at least one active hydrogen reactive to an epoxide group; and
c. at least one compound(S) of formula (I)

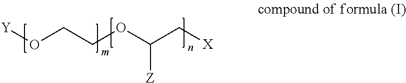

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.

Second aspect of the presently claimed invention is directed to a process for the preparation of a polymer (D) according to first aspect comprising the steps of:
a. providing at least one epoxide (E) having an average functionality of ≥3.0 and a number average molar weight in the range of from 250 to 25000 g/mol as determined according to GPC using THE as solvent;
b. providing at least one compound of formula (I)

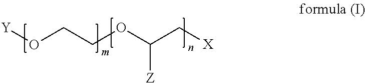

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from, linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl to obtain a mixture;
   c. providing at least one compound (P) having at least one pigment affinic group has at least one active hydrogen to obtain a ternary mixture and
   d. heating the mixture obtained in step c. to a desired temperature to obtain the product.

Third aspect of the presently claimed invention is directed to the use of a polymer (D) according to first aspects and/or second aspects as a dispersant for particulate solid material.

Fourth aspect of the presently claimed invention is directed to a composition in the form of a dispersion comprising,
a. the polymer (D) according to first aspect; and
b. at least one particulate solid material selected from pigments or fillers;
c. at least one liquid diluent, and
d. at least one polymeric binder,
   wherein the particulate solid material is dispersed in the liquid diluent selected from organic solvents or water or mixture from both.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

The term “Pigment-affinic group” or “anchor group” of a compound as used herein, refers to a chemical moiety having inherent strong affinity for pigment surfaces. “Pigment-affinic group” or “anchor group” of the compound adsorbs onto the pigment surface, thereby stabilizing the pigment by counteracting against any re-agglomeration of the pigments. “Pigment-affinic group” or “anchor group” can be classified into following categories based on the nature of the chemical moiety:
a) Acidic pigment-affinic group comprise a carboxyl moiety (—CO₂H), phosporic acid moiety (—PO₃H₂) and sulphonic acid (—SO₃H) moiety, including their neutralised and derivatized forms.
b) Electroneutral pigment-affinic group comprise polyether, substituted or unsubstituted aliphatic rings, substituted or unsubstituted aromatic rings (e.g. phenyl and naphtyl) and substituted or unsubstituted heterocyclic derivatives thereof.
c) Aminic pigment-affinic group comprise alkaline nitrogen containing moiety such as aniline, indole, imidazole, imide, morpholine, oxazolines, piperazine, polyethyleneimine, pyridine, trialkylamines, triazole.
d) Quaternary amine pigment-affinic group comprise a quarternary amine moiety.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a polymer (D) obtained by reacting:
a. at least one epoxide (E) having an average functionality of ≥3.0 and a number average molar weight in the range of from 250 to 25000 g/mol as determined according to GPC using THE as solvent;
b. at least one compound (P) having at least one pigment affinic group, wherein the pigment affinic group has at least one active hydrogen reactive to an epoxide group; and
c. at least one compound(S) of formula (I)

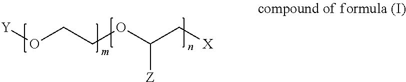

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from, linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.

More preferably, the polymer (D) is obtained by reacting:
a. at least one epoxide (E) having an average functionality of ≥3.0 to ≤10 and a number average molar weight in the range of from 250 to 20000 g/mol as determined according to GPC using THF as solvent;
b. at least one compound (P) having at least one pigment affinic group, wherein the pigment affinic group has at least one active hydrogen reactive to an epoxide group; and
c. at least one compound(S) of formula (I)

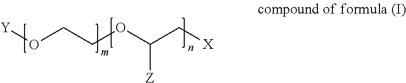

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.

Even more preferably, the polymer (D) is obtained by reacting:
a. at least one epoxide (E) having an average functionality of ≥3.0 to ≤10 and a number average molar weight in the range of from 250 to 20000 g/mol as determined according to GPC using THE as solvent;
b. at least one compound (P) having at least one pigment affinic group, wherein the pigment affinic group has at least one active hydrogen reactive to an epoxide group; and
c. at least one compound(S) of formula (I)

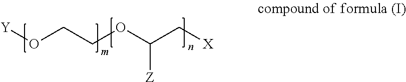

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 300,
n is 0 to 50,
X is selected from —OC(O)—R—C(O)OH, —NR¹C(O)—R—C(O)OH, —ORC(O)OH, —OC(O)—R—SH, —NHR¹ or —O—R—SH;
wherein R is selected from, linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and

R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.

Most preferably, the polymer (D) is obtained by reacting:
a. at least one epoxide (E) having an average functionality of ≥3.0 to ≤6.0 and a number average molar weight in the range of from 250 to 10000 g/mol as determined according to GPC using THE as solvent;
b. at least one compound (P) having at least one pigment affinic group, wherein the pigment affinic group has at least one active hydrogen reactive to an epoxide group; and
c. at least one compound(S) of formula (I)

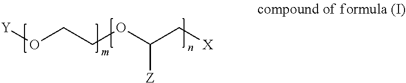

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 100,
n is 0 to 30,
X is selected from —OC(O)—R—C(O)OH, —NR¹C(O)—R—C(O)OH, or —ORC(O)OH;
wherein R is selected from, linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and

R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.

In particular the polymer (D) is obtained by reacting:
a. at least one epoxide (E) having an average functionality of ≥3.0 to ≤6.0 and a number average molar weight in the range of from 250 to 10000 g/mol as determined according to GPC using THE as solvent;
b. at least one compound (P) having at least one pigment affinic group, wherein the pigment affinic group has at least one active hydrogen reactive to an epoxide group; and
c. at least one compound(S) of formula (I)

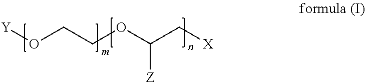

wherein Y is selected from hydrogen, C₁-C₄ alkyl, C₂-C₄ alkenyl or Cz to C₁₅ arylalkyl;
Z is independently selected from —CH₃, —C₂H₅, —C₃H₇, or —C₆H₆,
m is 5 to 100,
n is 0 to 20,
X is selected from —OC(O)—R—C(O)OH, —NHC(O)—R—C(O)OH or —ORC(O)OH; wherein
R is selected from C₁-C₄ alkyl, C₂-C₄ alkenyl, Cecycloaliphatic or C₆ aromatic.

In another preferred embodiment, the epoxide (E) according to the presently claimed invention has an average functionality in the range of 3 to 10, more preferably the epoxide (E) has an average functionality in the range of 3 to 8, even more preferably the epoxide (E) has an average functionality in the range of 3 to 6, most preferably the epoxide (E) has an average functionality in the range of 3 to 5, and in particular the epoxide (E) has an average functionality in the range of 3 to 5.

In another preferred embodiment, the epoxide (E) according to presently claimed invention is having a number average molecular weight in the range of 250 to 25000 g/mol as determined according to GPC using THE as solvent, more preferably the epoxide (E) has a number average molecular weight in the range of 500 to 20000 g/mol as determined according to GPC using THF as solvent, even more preferably the epoxide (E) has a number average molecular weight in the range of 500 to 10000 g/mol as determined according to GPC using THE as solvent, most preferably the epoxide (E) has a number average molecular weight in the range of 500 to 8000 g/mol as determined according to GPC using THE as solvent, and in particular the epoxide (E) has a number average molecular weight in the range of 500 to 5000 g/mol as determined according to GPC using THE as solvent.

In another preferred embodiment, the at least one epoxide (E) according to presently claimed invention is selected from

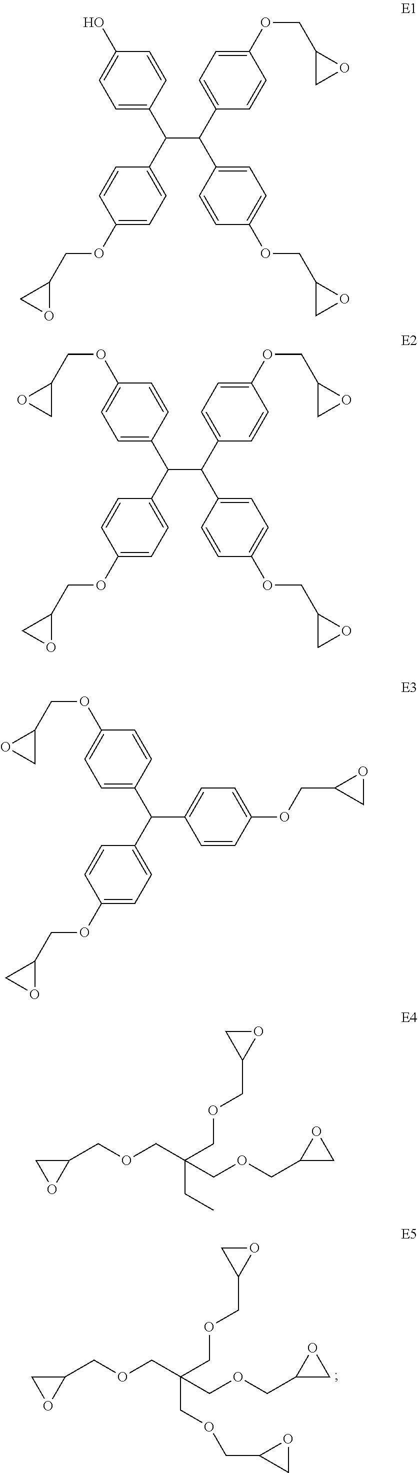

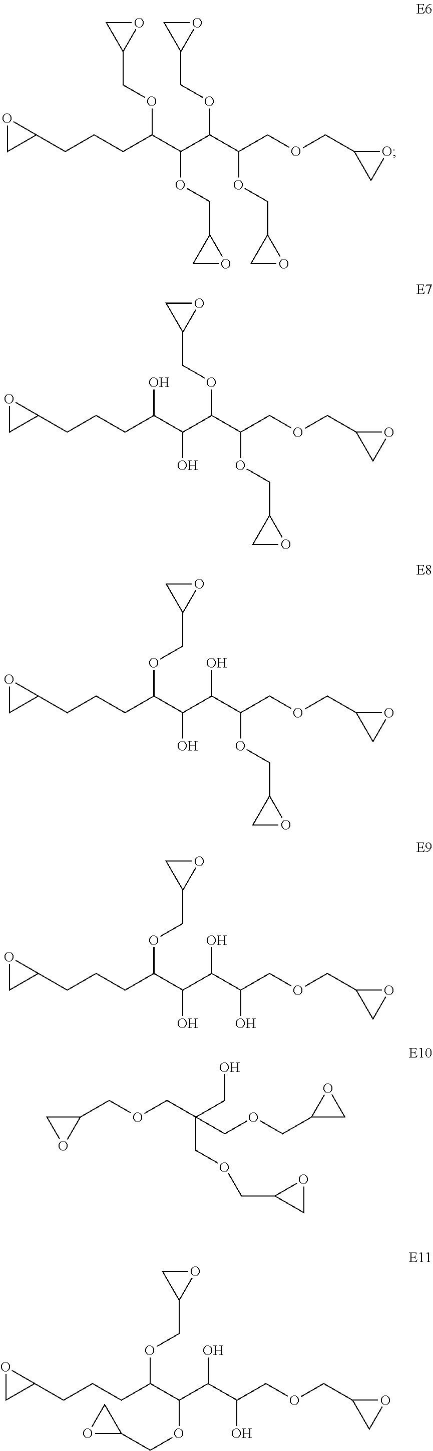

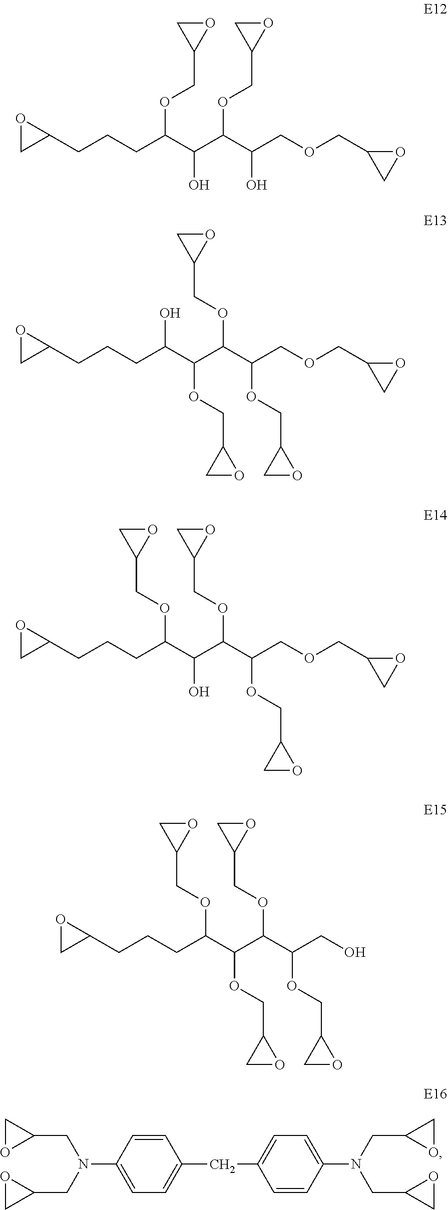 [SMILES: OC(COCC1CO1)C(OCC1CO1)C(O)C(CCCC1CO1)OCC1CO1 ; OC(CCCC1CO1)C(OCC1CO1)C(OCC1CO1)C(COCC1CO1)OCC1CO1 ; OC(C(CCCC1CO1)OCC1CO1)C(OCC1CO1)C(COCC1CO1)OCC1CO1 ; OCC(OCC1CO1)C(OCC1CO1)C(OCC1CO1)C(CCCC1CO1)OCC1CO1 ; c1cc(N(CC2CO2)CC2CO2)ccc1Cc1ccc(N(CC2CO2)CC2CO2)cc1]

polymeric forms thereof, or mixtures of two or more thereof.

More preferably the at least one epoxide (E) is selected from

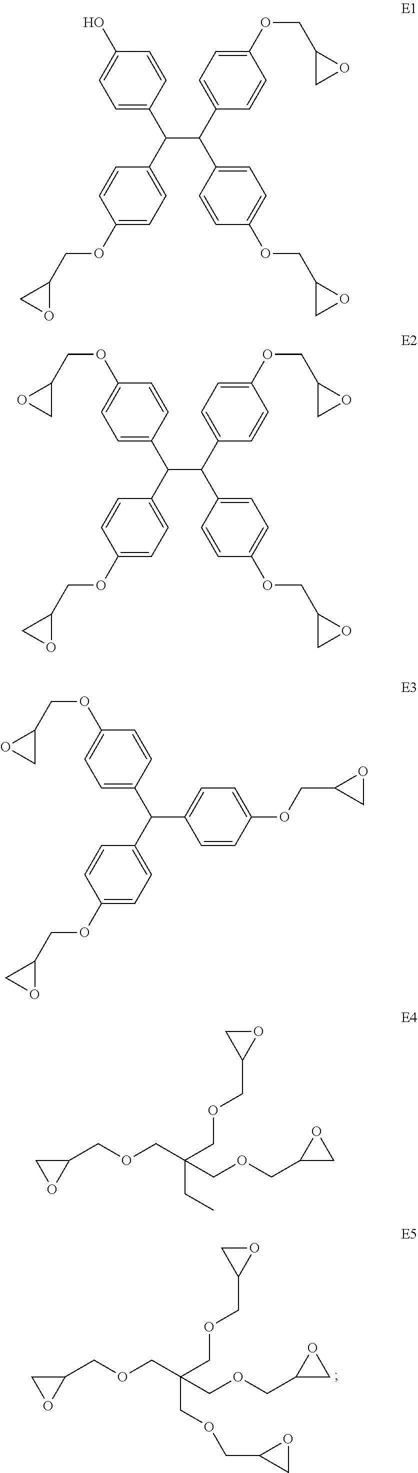

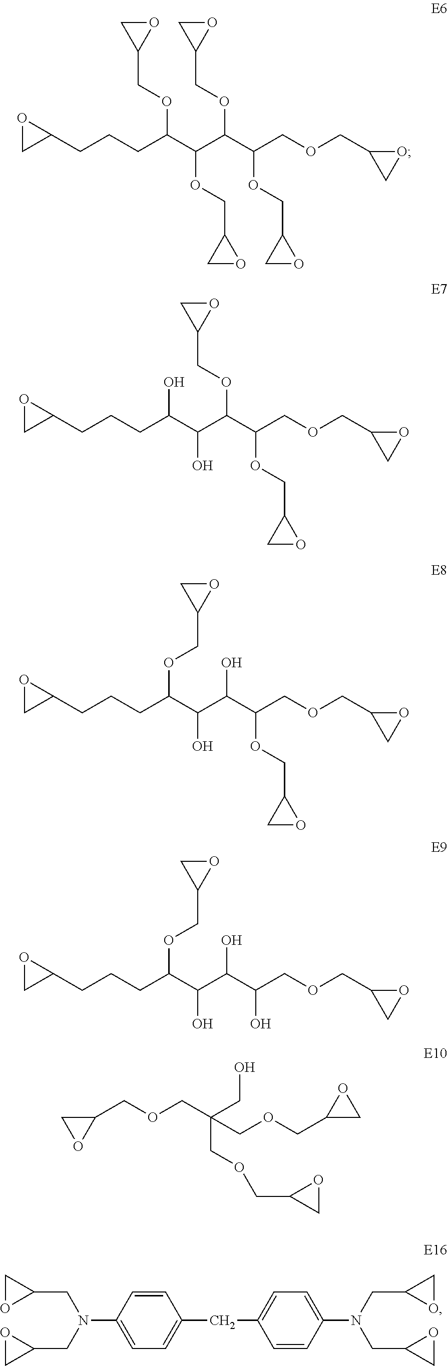

polymeric forms thereof, or mixtures of two or more thereof.

Even more preferably the at least one epoxide (E) is selected from

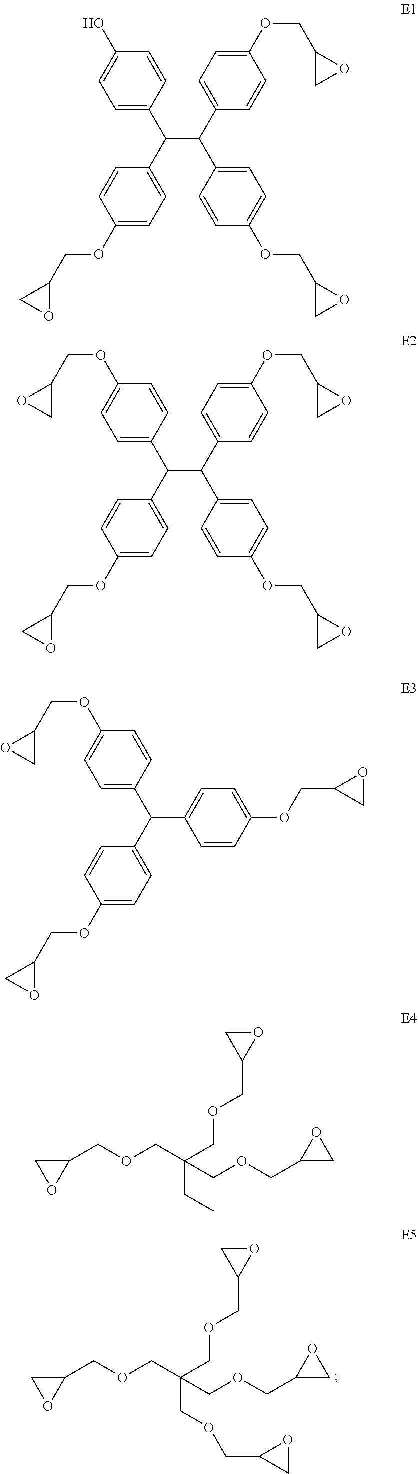

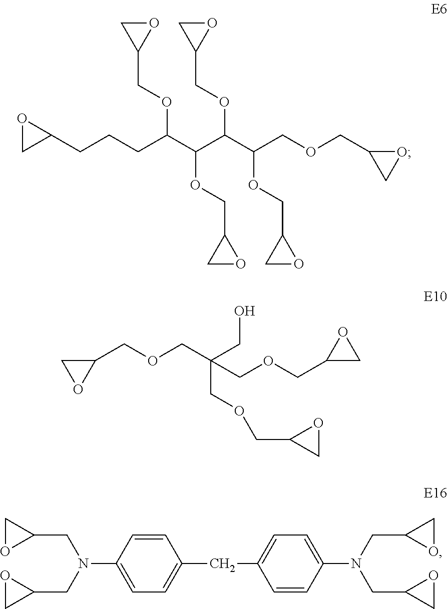 [SMILES: C(CC1CO1)CC(OCC1CO1)C(OCC1CO1)C(OCC1CO1)C(COCC1CO1)OCC1CO1 ; OCC(COCC1CO1)(COCC1CO1)COCC1CO1 ; c1cc(N(CC2CO2)CC2CO2)ccc1Cc1ccc(N(CC2CO2)CC2CO2)cc1]

polymeric forms thereof, or mixtures of two or more thereof.

Most preferably the at least one epoxide (E) is selected from

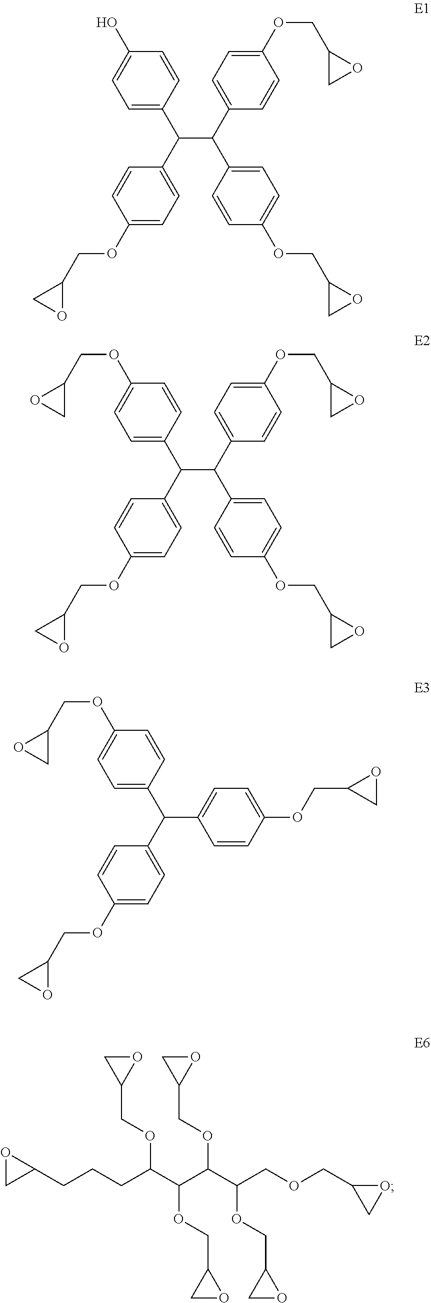

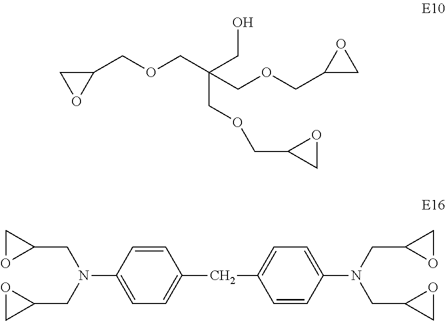 [SMILES: OCC(COCC1CO1)(COCC1CO1)COCC1CO1 ; c1cc(N(CC2CO2)CC2CO2)ccc1Cc1ccc(N(CC2CO2)CC2CO2)cc1]

polymeric forms thereof, or mixtures of two or more thereof.

In particular the at least one enoxide (F) is selected from

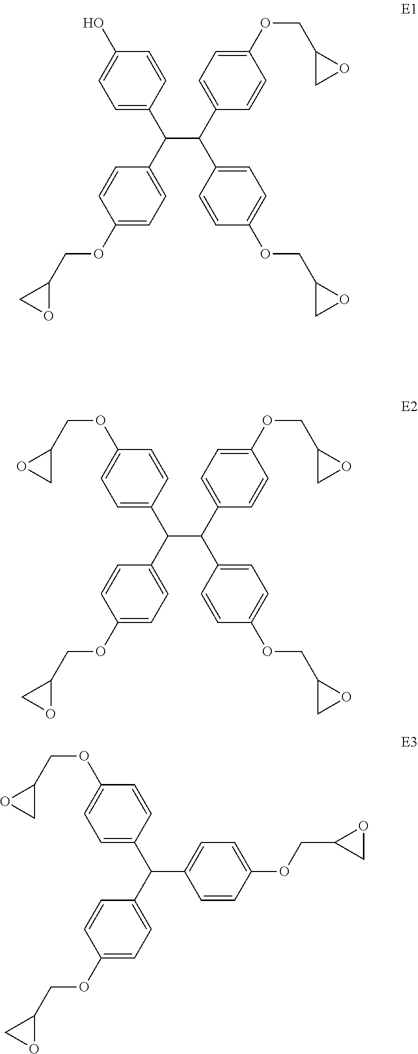

polymeric forms thereof, or mixtures of two or more thereof.

In another preferred embodiment, the polymeric forms of the epoxide (E) include dimers, trimers, oligomers and higher homologs.

In case more than one epoxide (E) is used, the polymeric forms may be mixed polymers comprising the different epoxides (E) is any amount.

Polymeric dispersants typically contain plurality of pigment affinic groups, also known as anchor groups in state-of-the-art, with a specific structure conducive for easy adsorption onto pigment surfaces, exhibiting a high affinity for the pigment surface, which gives durable adsorption onto the surface of the pigment to be dispersed.

In another preferred embodiment the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

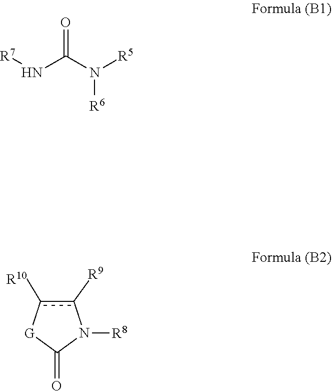

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, —NHR¹¹—, or —SH,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride (C) of formula selected from C(1), C(2), C(3) or C(4),

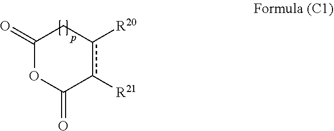

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl,
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
dotted line represents an optional bond, and
p is selected from 0, 1 or 2,

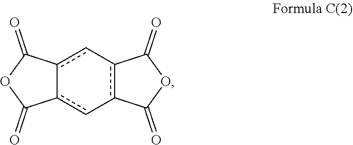

wherein dotted line represents an optional bond,

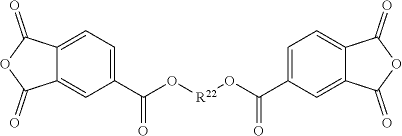

wherein R²² is selected from linear or branched, substituted or unsubstituted C₁-C₂₀ alkylene, linear or branched, substituted or unsubstituted C₂-C₃₀ alkenylene, linear or branched, substituted or unsubstituted C₁-C₂₀ hetero alkylene, substituted or unsubstituted C₆-C₁₀ cycloalkylene or linear or branched, substituted or unsubstituted C₆-C₁₀ arylene,
dotted line represents an optional bond; and

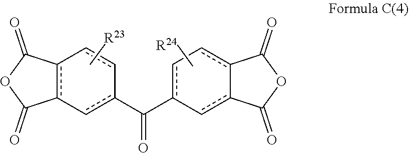

wherein R²³ and R²⁴ independently selected from hydrogen, halogen, —NO₂, or SO₃H, and
dotted line represents an optional bond, or mixtures of two or more thereof.

More preferably the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

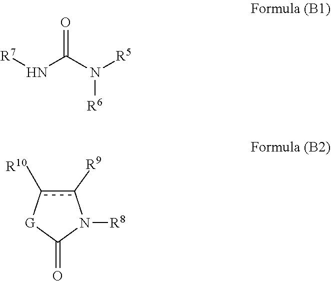

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, —NHR¹¹—, or —SH,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula C(1),

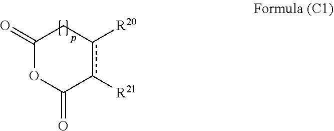

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
dotted line represents an optional bond, and
p is selected from 0, 1 or 2,
or mixtures of two or more thereof.

Even more preferably the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

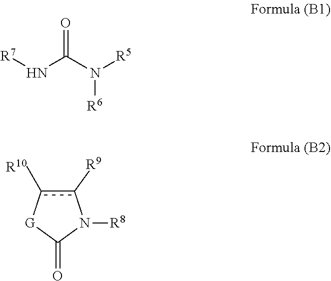

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, —NHR¹¹—, or —SH,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula (C₁),

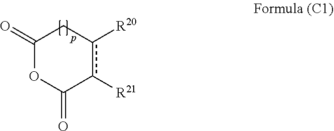

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 10-membered carbocyclic ring that optionally contains 1, 2 or 3 heteroatom(s) selected from O, N or S as ring member(s);
dotted line represents an optional bond, and
p is selected from 0, 1 or 2,
or mixtures of two or more thereof.

Most preferably the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

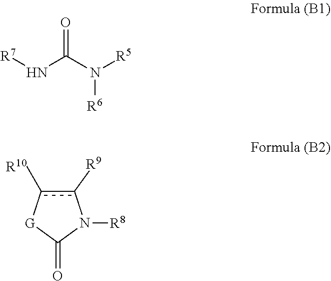

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 10-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, or —NHR¹¹—,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula C(1),

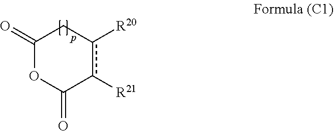

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 10-membered carbocyclic ring that optionally contains 1, 2 or 3 heteroatom(s) selected from O, N or S as ring member(s);
dotted line represents an optional bond, and
p is selected from 0, 1 or 2,
or mixtures of two or more thereof.

In particular preferably the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or

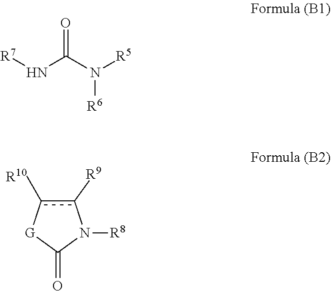

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₁₅ alkyl, linear or branched, substituted or unsubstituted C₂-C₁₆ alkenyl, substituted or unsubstituted C₅-C₁₀ cycloalkyl, substituted or unsubstituted C₅-C₁₀ cycloalkenyl, linear or branched, substituted or unsubstituted C₇ to C₁₅ arylalkyl, substituted or unsubstituted C₆-C₇ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 10-membered carbocyclic ring that optionally contains 1, 2 or 3 heteroatom(s) selected from O or N as ring member(s);
with the proviso that at least one of R⁵, R⁶, R⁷, R⁸, R⁹ or R¹⁰ is substituted with at least one —OH, or —NHR¹¹—,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula C(1),

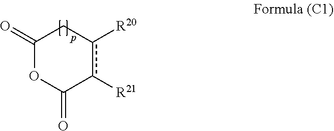

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 10-membered carbocyclic ring that optionally contains 1, 2 or 3 heteroatom(s) selected from O, N or S as ring member(s);
dotted line represents an optional bond, and
p is selected from 0, or 1,
or mixtures of two or more thereof.

In another preferred embodiment, the at least one compound (P) having at least one pigment affinic group has at least one active hydrogen is a reaction product obtained by reacting N-(2-hydroxyethyl) ethylene urea with at least one anhydride of formula (C₁),

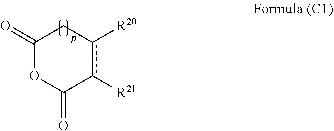

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
   dotted line represents an optional bond, and
   p is selected from 0, 1 or 2.

More preferably the at least one compound (P) having at least one pigment affinic group has at least one active hydrogen is a reaction product obtained by reacting N-(2-hydroxyethyl) ethylene urea with at least one anhydride of formula (C₁).

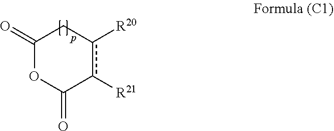

wherein R²⁰ and R²¹ are independently selected from hydrogen, linear or branched, substituted or unsubstituted C₁-C₂₀ alkyl, linear or branched, substituted or unsubstituted C₂-C₂₀ alkenyl, substituted or unsubstituted C₅-C₁₄ cycloalkyl, substituted or unsubstituted C₅-C₁₄ cycloalkenyl, linear or branched, substituted or unsubstituted C₇ to C₁₅ arylalkyl, or substituted or unsubstituted C₆-C₁₀ aryl, or
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
dotted line represents an optional bond, and
p is selected from 0, 1 or 2.

Even more preferably the at least one compound (P) having at least one pigment affinic group has at least one active hydrogen is a reaction product obtained by reacting N-(2-hydroxyethyl) ethylene urea with at least one anhydride of formula (C₁),

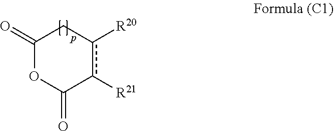

wherein R²⁰ and R²¹ are independently selected from hydrogen, linear or branched, substituted or unsubstituted C₁-C₁₆ alkyl, linear or branched, substituted or unsubstituted C₂-C₂₀ alkenyl, substituted or unsubstituted C₅-C₁₀ cycloalkyl, substituted or unsubstituted C₅-C₁₀ cycloalkenyl, linear or branched, substituted or unsubstituted C₇ to C₁₅ arylalkyl, or substituted or unsubstituted C₆-C₈ aryl, or
R²⁰ and R²¹ together with the carbon atoms to which they are bonded form substituted or unsubstituted unsaturated or aromatic 5- to 10-membered carbocyclic ring that optionally contains 1, 2 or 3 heteroatom(s) selected from O, N or S as ring member(s);
   dotted line represents an optional bond, and
   p is selected from 0, 1 or 2.

Most preferably the at least one compound (P) having at least one pigment affinic group has at least one active hydrogen is a reaction product obtained by reacting N-(2-hydroxyethyl) ethylene urea with at least one anhydride of formula (C₁),

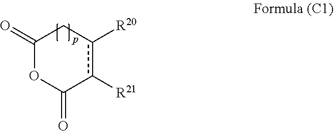

wherein R²⁰ and R²¹ are independently selected from hydrogen, linear or branched, substituted or unsubstituted C₁-C₁₆ alkyl, linear or branched, substituted or unsubstituted C₂-C₁₆ alkenyl, substituted or unsubstituted C₅-C₈ cycloalkyl, substituted or unsubstituted C₅-C₈ cycloalkenyl, linear or branched, substituted or unsubstituted C₇ to C₁₅ arylalkyl, or substituted or unsubstituted C₆-C₈ aryl, or
R²⁰ and R²¹ together with the carbon atoms to which they are bonded form substituted or unsubstituted unsaturated or aromatic 5- to 8-membered carbocyclic ring that optionally contains 1, 2 or 3 heteroatom(s) selected from O, N or S as ring member(s);
   dotted line represents an optional bond, and
   p is selected from 0, 1 or 2.

In particular the at least one compound (P) having at least one pigment affinic group has at least one active hydrogen is a reaction product obtained by reacting N-(2-hydroxyethyl) ethylene urea with at least one anhydride of formula (C1),

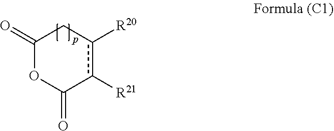

wherein R²⁰ and R²¹ are independently selected from hydrogen, linear or branched, substituted or unsubstituted C₁-C₁₆ alkyl, linear or branched, substituted or unsubstituted C₂-C₁₆ alkenyl, substituted or unsubstituted C₅-C₆ cycloalkyl, substituted or unsubstituted C₅-C₆ cycloalkenyl, linear or branched, substituted or unsubstituted C₇ to C₁₀ arylalkyl, or substituted or unsubstituted C₆ aryl, or
R²⁰ and R²¹ together with the carbon atoms to which they are bonded form substituted or unsubstituted unsaturated or aromatic 5- to 6-membered carbocyclic ring that optionally contains 1, or 2 heteroatom(s) selected from O, or N as ring member(s);
   dotted line represents an optional bond, and
   p is selected from 0, or 1.

In another preferred embodiment the at least one anhydride according to presently claimed invention is selected from

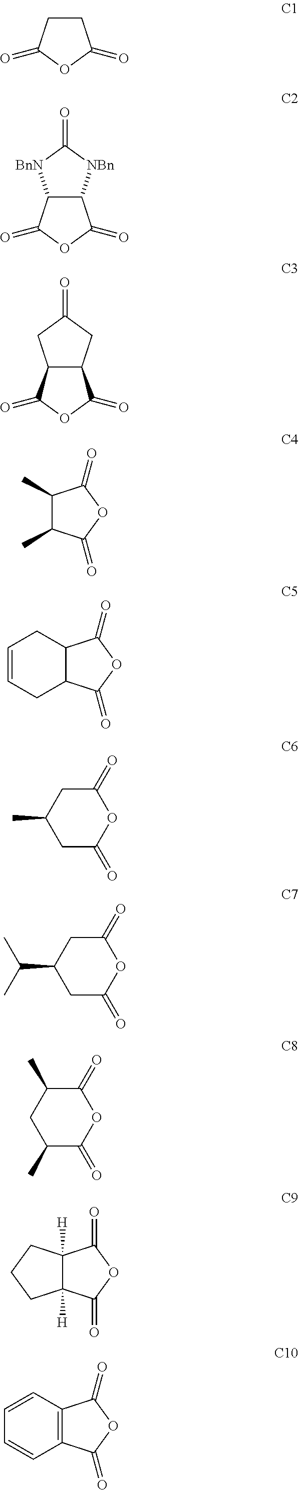

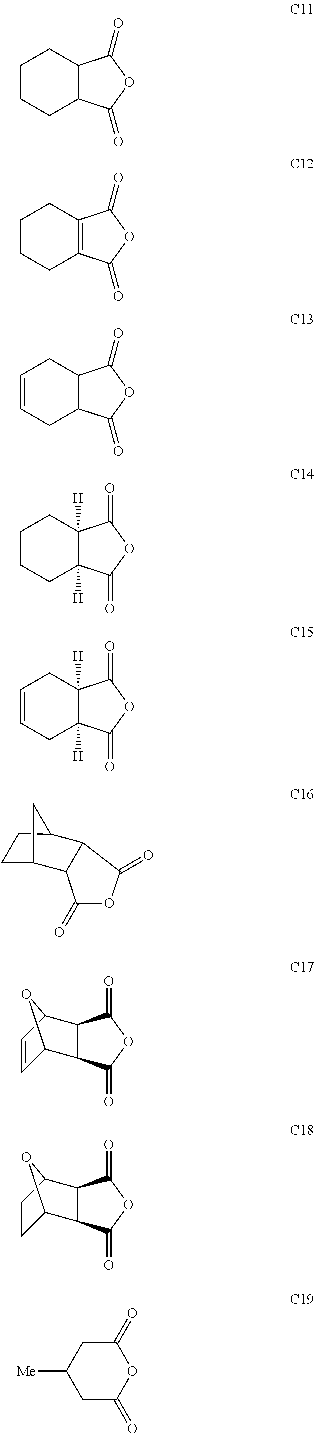

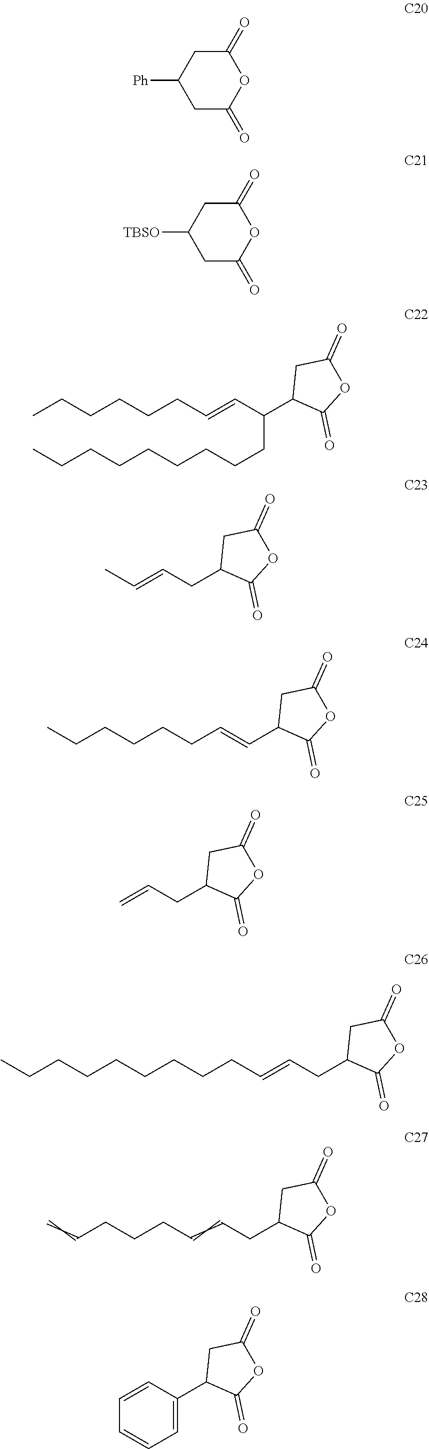

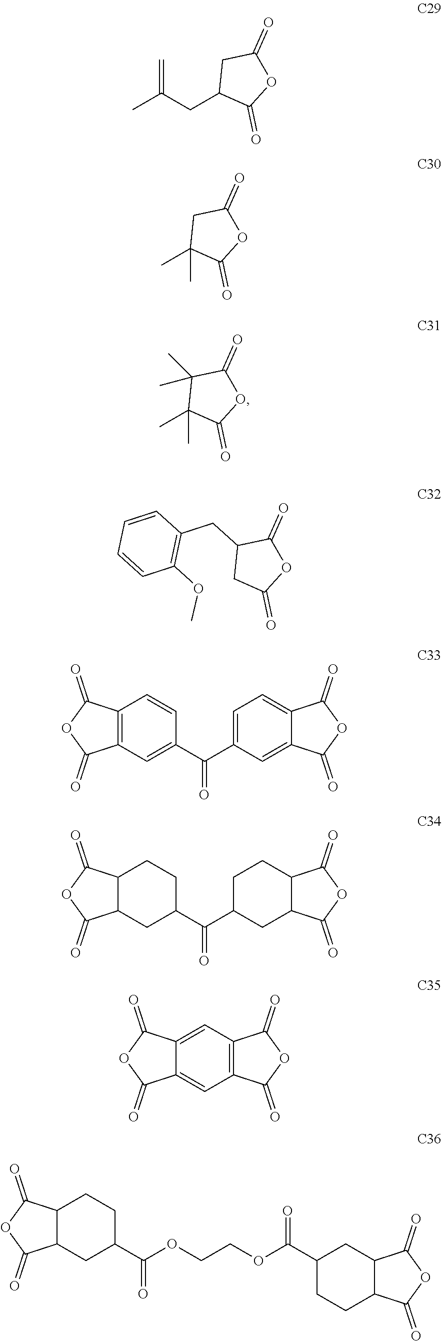

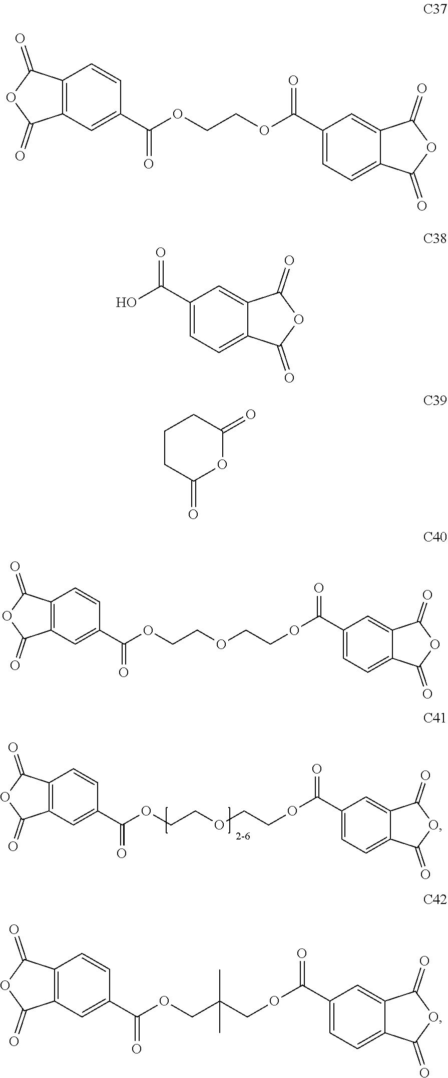

or mixtures of two or more thereof.

More preferably the at least one anhydride according to presently claimed invention is selected from

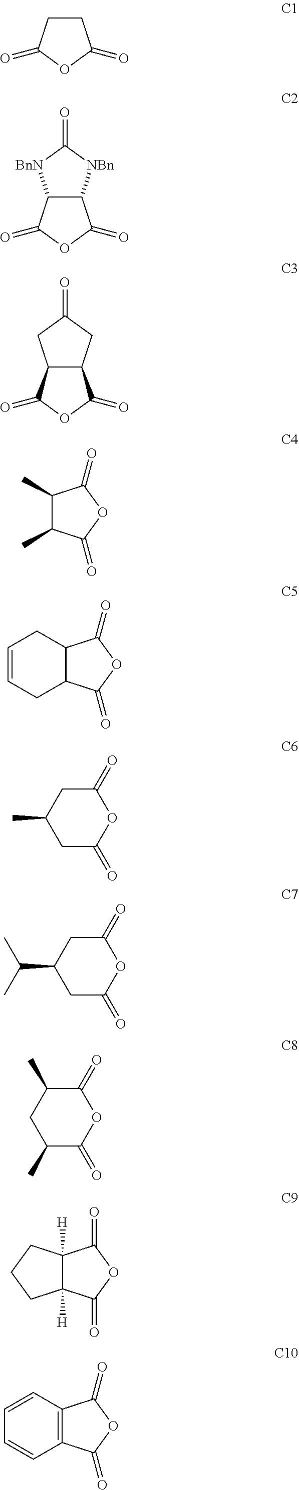

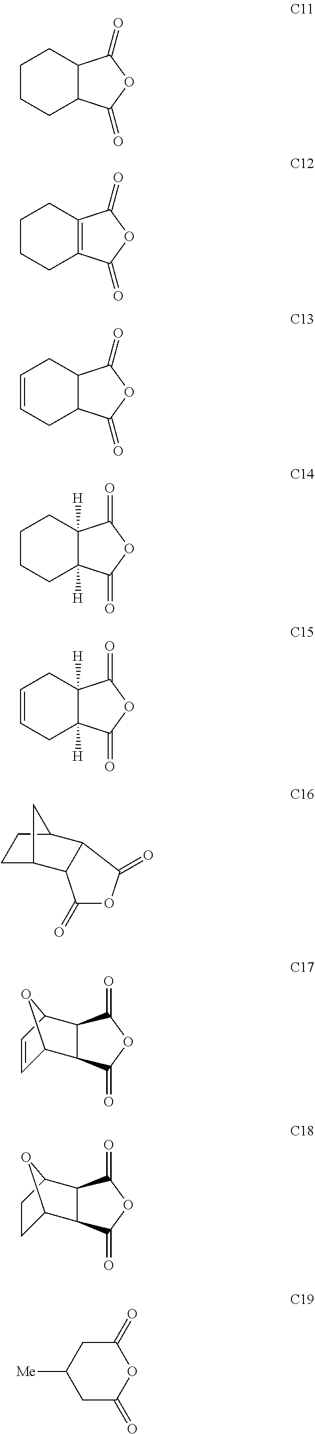

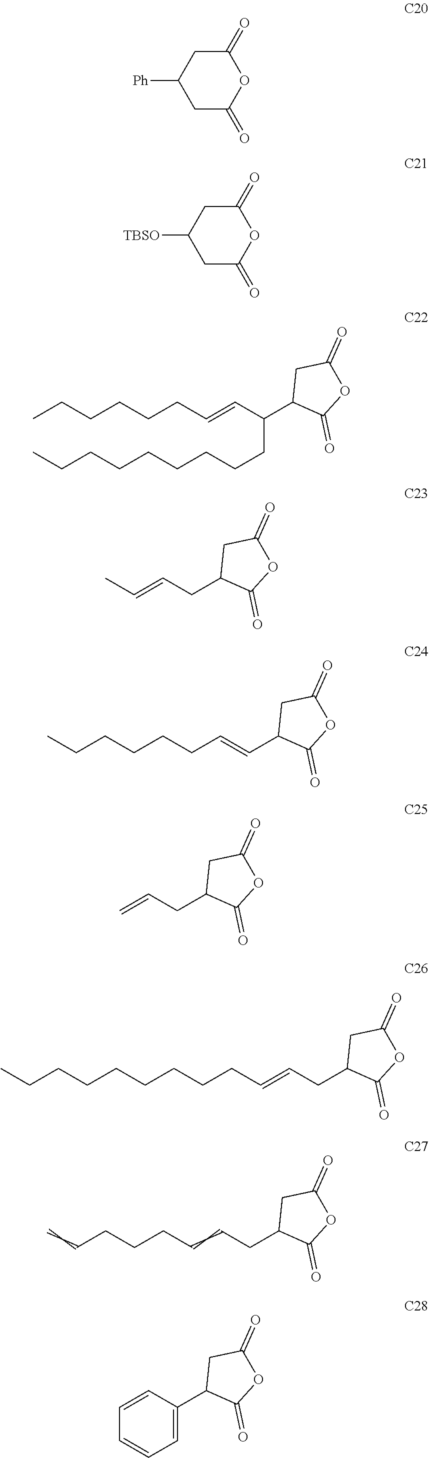

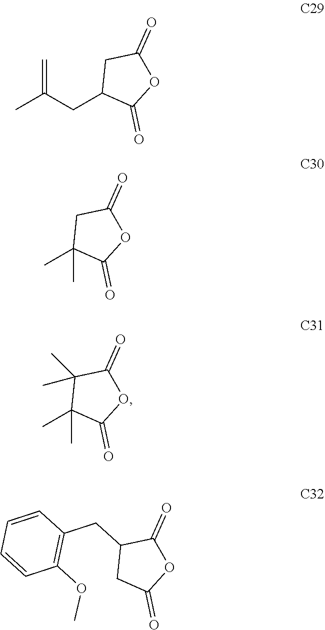

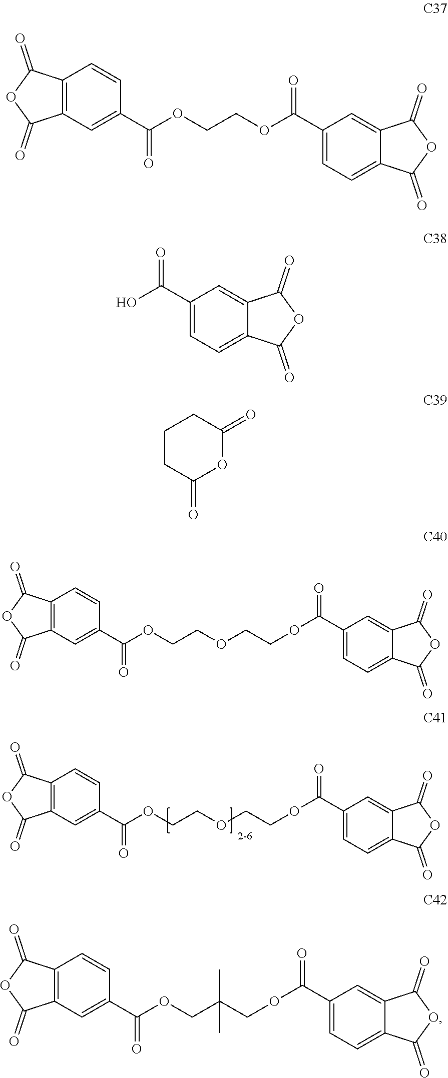

or mixtures of two or more thereof.

Even more preferably the at least one anhydride according to presently claimed invention is selected from

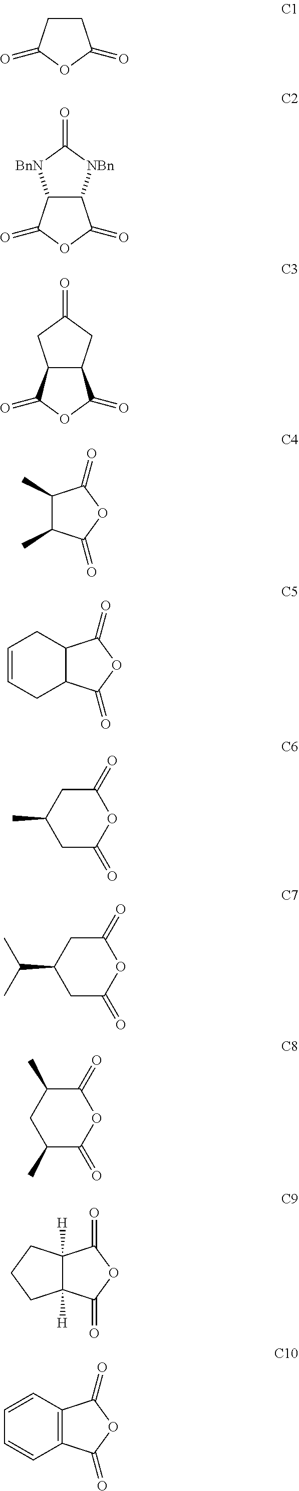

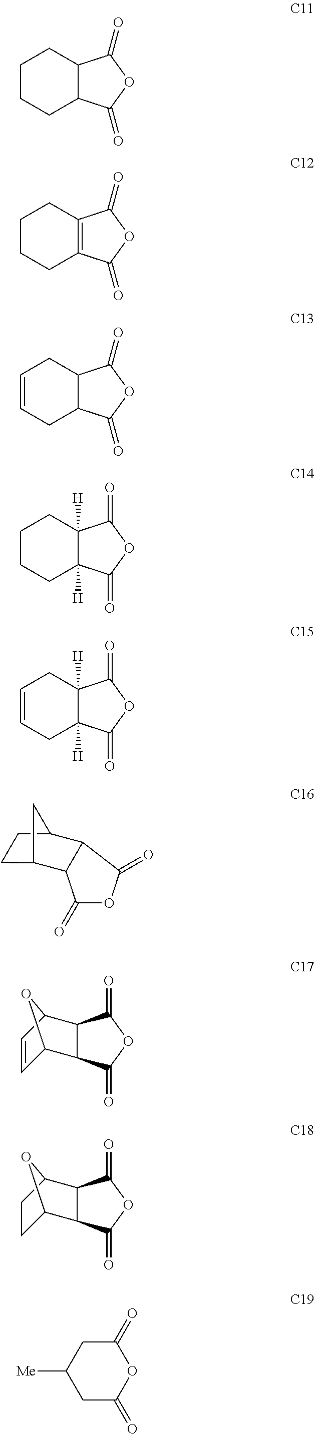

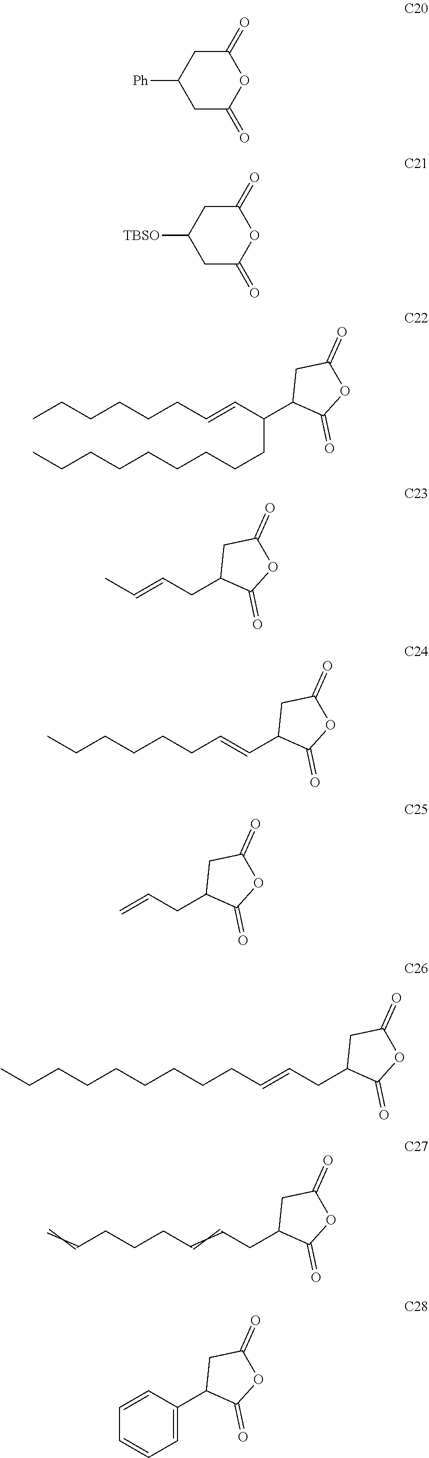

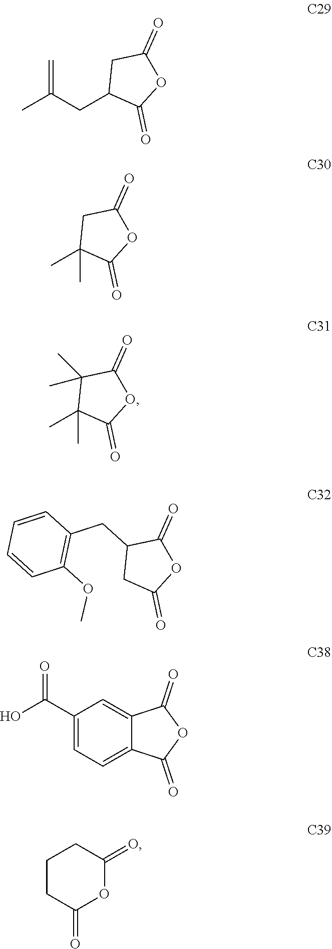

or mixtures of two or more thereof.

Most preferably the at least one anhydride according to presently claimed invention is selected from

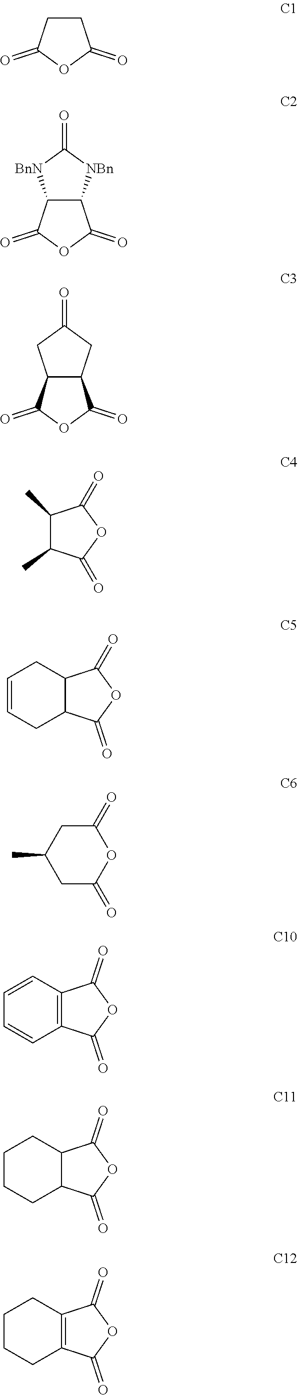

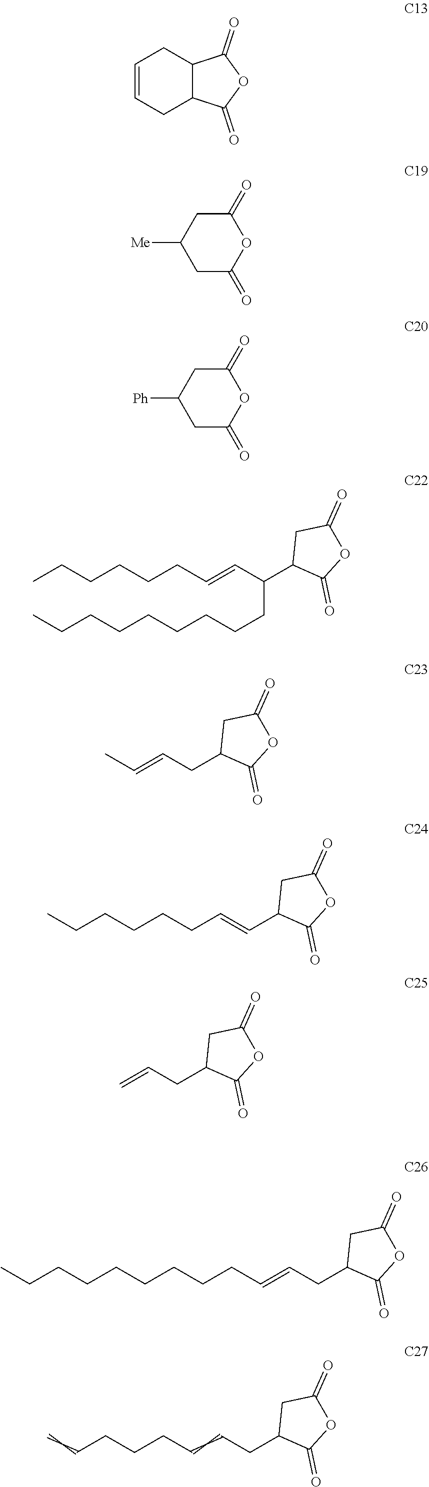

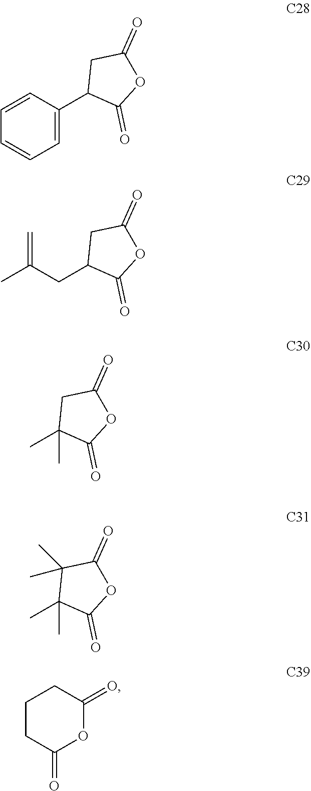

or mixtures of two or more thereof.

In particular the at least one anhydride according to presently claimed invention is selected from

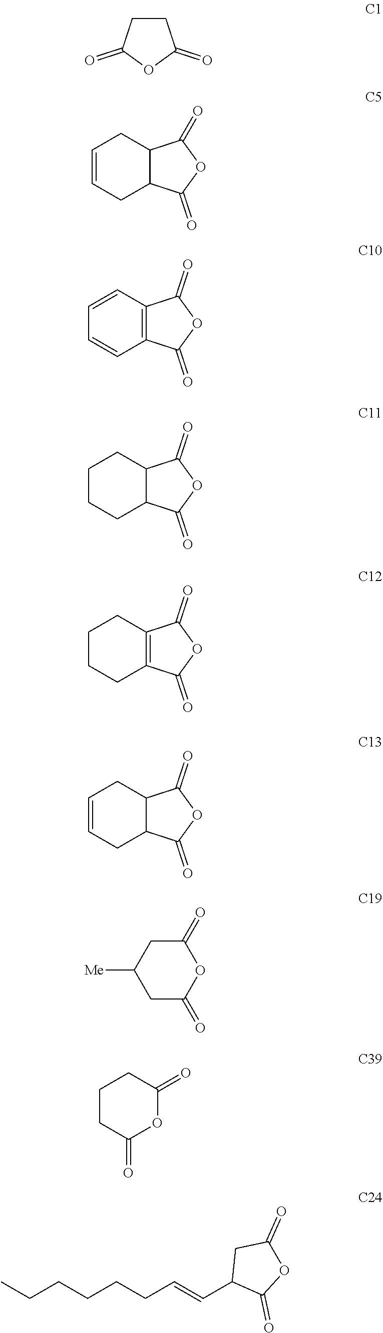

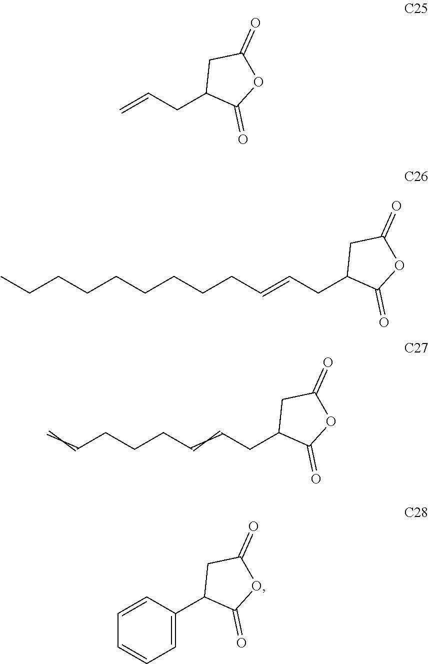

or mixtures of two or more thereof.

In another preferred embodiment, according to presently claimed invention the at least one compound of formula (I) is

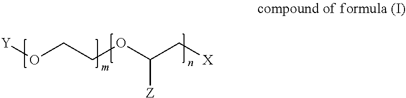

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted Cz to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl;
more preferably Y is selected from hydrogen, linear or branched, substituted or unsubstituted C₁-C₂₀ alkyl, linear or branched, substituted or unsubstituted C₂-C₂₀ alkenyl or linear or branched, substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
   Z is selected from C₁-C₆ alkyl or C₆-C₁₀ aryl,
   m is 5 to 200,
   n is 0 to 50,
   X is selected from —OC(O)—R—C(O)OH, —NR¹C(O)—R—C(O)OH, —ORC(O)OH, —OC(O)—R—SH, —NHR¹ or —O—R—SH;
   wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
   R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl; even more preferably Y is selected from hydrogen, linear or branched, substituted or unsubstituted C₁-C₁₆ alkyl, linear or branched, substituted or unsubstituted C₂-C₁₆ alkenyl or substituted or unsubstituted C₆-C₁₀ cycloalkyl, substituted or unsubstituted C₇ to C₁₅ arylalkyl, or substituted or unsubstituted C₆-C₁₀ aryl
   Z is selected from C₁-C₆ alkyl or C₆-C₁₀ aryl,
   m is 5 to 100,
   n is 0 to 25,
   X is selected from —OC(O)—R—C(O)OH, —NR¹C(O)—R—C(O)OH, —ORC(O)OH, —OC(O)—R—SH, —NHR¹ or —O—R—SH;
   wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
   R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl; most preferably Y is selected from hydrogen, linear or branched, substituted or unsubstituted C₁-C₁₀ alkyl, linear or branched, substituted or unsubstituted C₂-C₁₀ alkenyl or substituted or unsubstituted C₆-C₇ cycloalkyl, substituted or unsubstituted C₇ to C₁₀ arylalkyl, or substituted or unsubstituted C₆ aryl
   Z is selected from C₁-C₃ alkyl or Ce aryl,
   m is 5 to 100,
   n is 0 to 20,
   X is selected from —OC(O)—R—C(O)OH, —NR¹C(O)—R—C(O)OH, or —ORC(O)OH;
   wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
   R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl; and in particular Y is selected from hydrogen, C₁-C₁₈ alkyl, C₂-C₁₈ alkenyl or C₇ to C₁₅ arylalkyl; Z is independently selected from —CH₃, —C₂H₅, —C₃H₇, or —C₆H₆,
   m is 5 to 100,
   n is 0 to 20,
   X is selected from —OC(O)—R—C(O)OH, —NHC(O)—R—C(O)OH or —ORC(O)OH; wherein
   R is selected from C₁-C₁₀ alkyl, C₂-C₁₀ alkenyl, C₆-C₁₀ cycloaliphatic or C₆ aromatic,
   R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, or substituted or unsubstituted C₆-C₁₀ aryl.

In another preferred embodiment the compound of formula (I) is a random copolymer or a block copolymer and comprises at least 50 wt. % of ethylene oxide in polymerized form based on the overall weight of compound of formula (I), more preferably the compound of formula (I) is a random copolymer or a block copolymer and comprises at least 70 wt. % of ethylene oxide in polymerized form based on the overall weight of compound of formula (I), even more the compound of formula (I) is a random copolymer or a block copolymer and comprises at least 75 wt. % of ethylene oxide in polymerized form based on the overall weight of compound of formula (I), most the compound of formula (I) is a random copolymer or a block copolymer and comprises at least 90 wt. % of ethylene oxide in polymerized form based on the overall weight of compound of formula (I) and in particular the compound of formula (I) is a random copolymer or a block copolymer and comprises 100 wt. % of ethylene oxide in polymerized form based on the overall weight of compound of formula (I).

In another preferred embodiment, the compound of formula (I) is a random copolymer or a block copolymer and comprises ethylene oxide in polymerized from in the range of 50 to 100 wt. % based on overall weight of compound of formula (I).

In another preferred embodiment, the compound of formula (I) according to presently claimed invention is a random copolymer or a block copolymer comprising ethylene oxide in polymerized form in the range of 50 to 100 wt. % and propylene oxide in polymerized form in the range of 0 to 50 wt. %, each based on overall weight of the compound of formula (I), more preferably the compound of formula (I) is a random copolymer or a block copolymer comprising ethylene oxide in polymerized form in the range of 60 to 100 wt. % and propylene oxide in polymerized form in the range of 0 to 40 wt. %, each based on overall weight of the compound of formula (I), even more preferably the compound of formula (I) is a random copolymer or a block copolymer comprising ethylene oxide in polymerized form the range of 75 to 100 wt. % and propylene oxide in polymerized form in the range of 0 to 25 wt. %, each based on overall weight of the compound of formula (I), most preferably the compound of formula (I) is a random copolymer or a block copolymer comprising ethylene oxide in polymerized form the range of 90 to 100 wt. % and propylene oxide in polymerized form the range of 0 to 10 wt. %, each based on overall weight of compound of formula (I), and in particular the compound of formula (I) is a polymer comprising 100 wt. % ethylene oxide based on overall weight of compound of formula (I).

In another preferred embodiment, the ratio of the total mole eq. of epoxides (E) to the total mole eq of compounds (P) in the dispersant is in the range of 1:0.25 to 1:0.90, more preferably the ratio of the total mole eq of epoxides (E) to the total mole eq. of compounds (P) in the dispersant is in the range of 1:0.35 to 1:0.80, even more preferably the ratio of the total mole eq. of epoxides (E) to the total mole eq. of compounds (P) in the dispersant is in the range of 1:0.4 to 1:0.80, most preferably the ratio of the total mole eq. of epoxides (E) to the total mole eq. of compounds (P) in the dispersant is in the range of 1:0.40 to 1:0.75, and in particular the ratio of the total mole eq. of epoxides (E) to the total mole eq. of compounds (P) in the dispersant is in the range of 0.55 to 0.75.

In another preferred embodiment, the ratio of the total mole eq. of epoxides (E) to the total mole eq. of compounds of formula (I) in the dispersant is in the range of 1:0.10 to 1:0.75, more preferably the ratio of the total mole eq. of epoxides (E) to the total mole eq. of compounds of formula (I) in the dispersant is in the range of 1:0.10 to 1:0.65, even more preferably the ratio of the total mole eq. of epoxides (E) to the total mole eq. of compounds of formula (I) in the dispersant is in the range of 1:0.20 to 1:0.50, most preferably the ratio of the total mole eq. of epoxides (E) to the total mole eq. of compounds of formula (I) in the dispersant is in the range of 1:0.20 to 1:0.45, and in particular the ratio of the total mole eq. of epoxides (E) to the total mole eq. of compounds of formula (I) in the dispersant is in the range of 1:0.25 to 1:0.40.

In another preferred embodiment, the ratio of the mole eq. of epoxides (E) to the sum of mole eq. of compounds of formula (I) and compound of formula (P) is in the range of 1:0.50 to 1:1.75, more preferably the ratio of the mole eq. of epoxides (E) to the sum of mole eq. of compounds of formula (I) and compound of formula (P) is in the range of 1:0.70 to 1:1.5, even more preferably the ratio of the mole eq. of epoxides (E) to the sum of mole eq. of compounds of formula (I) and compound of formula (P) is in the range of 1:0.80 to 1:1.2, most preferably the ratio of the mole eq. of epoxides (E) to the sum of mole eq. of compounds of formula (I) and compound of formula (P) is in the range of 1:0.90 to 1:1.1, and in particular the ratio of the mole eq. of epoxides (E) to the sum of mole eq. of compounds of formula (I) and compound of formula (P) is in the range of 1:0.95 to 1:1.

In another preferred embodiment, the polymer (D) according to presently claimed invention is a with a hyper branched polymer architecture. The term “hyperbranched” within the context of the presently claimed invention, means a polymer having a plurality of branch points and multifunctional branches. Hyperbranched polymers form a polydisperse system with varying degrees of branching.

In another preferred embodiment, the polymer (D) according to presently claimed invention is having a number average molecular weight in the range of 1000 to 100000 g/mol as measured using GPC using 1 mol/L Acetic acid in THE as eluant, more preferably the polymer (D) is having a number average molecular weight in the range of 1000 to 80000 g/mol as measured using GPC using 1 mol/L Acetic acid in THE as eluant, even more preferably the polymer (D) according to presently claimed invention is having a number average molecular weight in the range of 1000 to 60000 g/mol as measured using GPC using 1 mol/L Acetic acid in THE as eluant, and most preferably the polymer (D) according to presently claimed invention is having a number average molecular weight in the range of 1000 to 50000 g/mol as measured using GPC using 1 mol/L Acetic acid in THF as eluant. The column used is PSS SDV 10e6+10e5+10e3, 8×300 mm, 5 μm and kept at 35° C. The instrument was calibrated with Polymethylmethacrylate with a flow rate of effluent at 1 mL/min.

In another embodiment, the presently claimed invention is directed to a process for the preparation of a polymer (D) comprising the steps of:
a. providing at least one epoxide (E) having an average functionality of ≥3.0 and a number average molar weight in the range of from 250 to 25000 g/mol as determined according to GPC using THE as solvent;
b. providing at least one compound of formula (I)

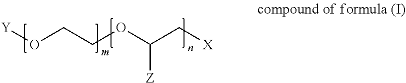

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from, linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl to obtain a mixture;
c. providing at least one compound (P) having at least one pigment affinic group has at least one active hydrogen to obtain a ternary mixture and
d. heating the mixture obtained in step c. to a desired temperature to obtain the product.

More preferably the presently claimed invention is directed to a process for the preparation of a polymer (D) comprising the steps of:
a. providing at least one epoxide (E) having an average functionality of ≥3.0 and a number average molar weight in the range of from 250 to 25000 g/mol as determined according to GPC using THE as solvent;
b. providing at least one compound of formula (I)

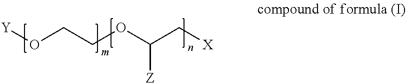

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted Cz to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 300,
n is 0 to 50,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl;
   c. providing at least one compound (P) having at least one pigment affinic group has at least one active hydrogen to obtain a ternary mixture and
   d. heating the mixture obtained in step c. to a desired temperature to obtain the product.

Even more preferably the presently claimed invention is directed to a process for the preparation of a polymer (D) comprising the steps of:
a. providing at least one epoxide (E) having an average functionality of ≥3.0 and a number average molar weight in the range of from 250 to 25000 g/mol as determined according to GPC using THE as solvent;
b. providing at least one compound of formula (I)

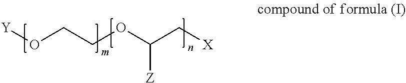

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 100,
n is 0 to 30,
X is selected from —OC(O)—R—C(O)OH, —NR¹C(O)—R—C(O)OH, or —ORC(O)OH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl;
   c. providing at least one compound (P) having at least one pigment affinic group has at least one active hydrogen to obtain a ternary mixture and
   d. heating the mixture obtained in step c. to a desired temperature to obtain the product.

Most preferably the presently claimed invention is directed to a process for the preparation of a polymer (D) comprising the steps of:
a. providing at least one epoxide (E) having an average functionality of ≥3.0 and a number average molar weight in the range of from 250 to 25000 g/mol as determined according to GPC using THE as solvent;
b. providing at least one compound of formula (I)

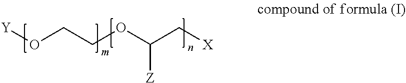

wherein X is selected from hydrogen, C₁-C₁₈ alkyl, C₂-C₁₈ alkenyl or C₇ to C₁₅ arylalkyl;
Z is independently selected from —CH₃, —C₂H₅, —C₃H₇, or —C₆H₆,
m is 5 to 100,
n is 0 to 20,
X is selected from —OC(O)—R—C(O)OH, —NHC(O)—R—C(O)OH or —ORC(O)OH; wherein
R is selected from C₁-C₁₀ alkyl, C₂-C₁₀ alkenyl, C₆-C₁₀ cycloaliphatic or C₆ aromatic,
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, or substituted or unsubstituted C₆-C₁₀ aryl;
   c. providing at least one compound (P) having at least one pigment affinic group has at least one active hydrogen to obtain a ternary mixture and
   d. heating the mixture obtained in step c. to a desired temperature to obtain the product.

In particular presently claimed invention is directed to a process for the preparation of a polymer (D) comprising the steps of:
a. providing at least one epoxide (E) is selected from

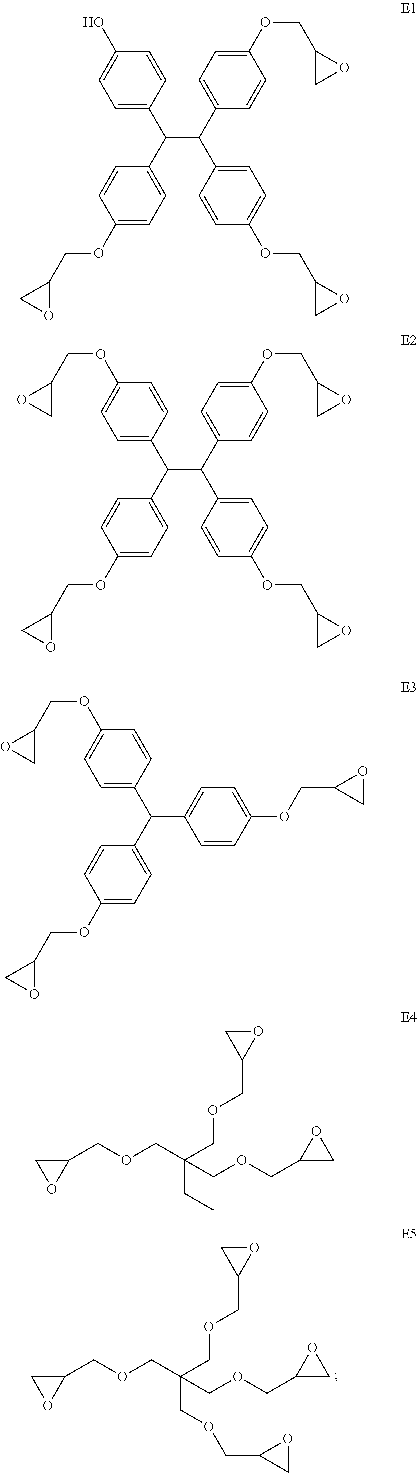

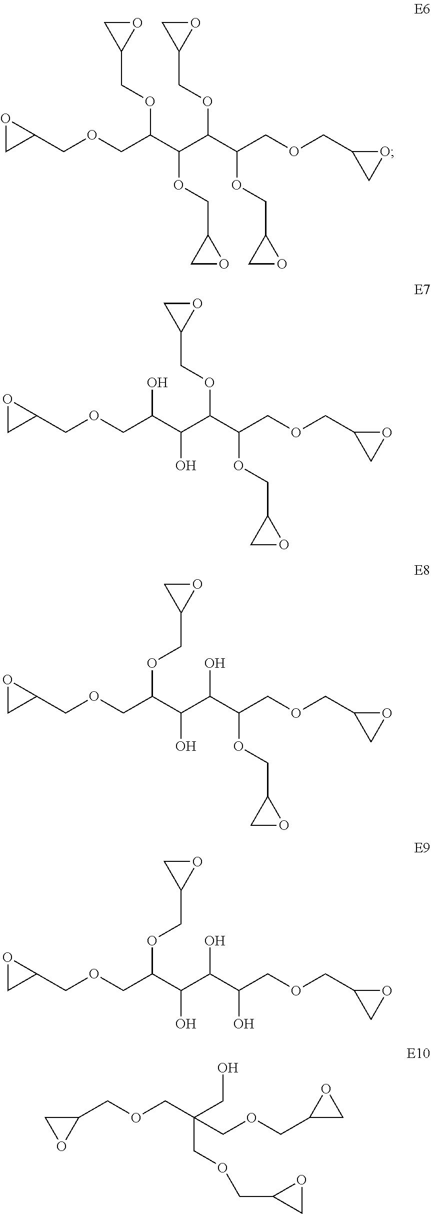

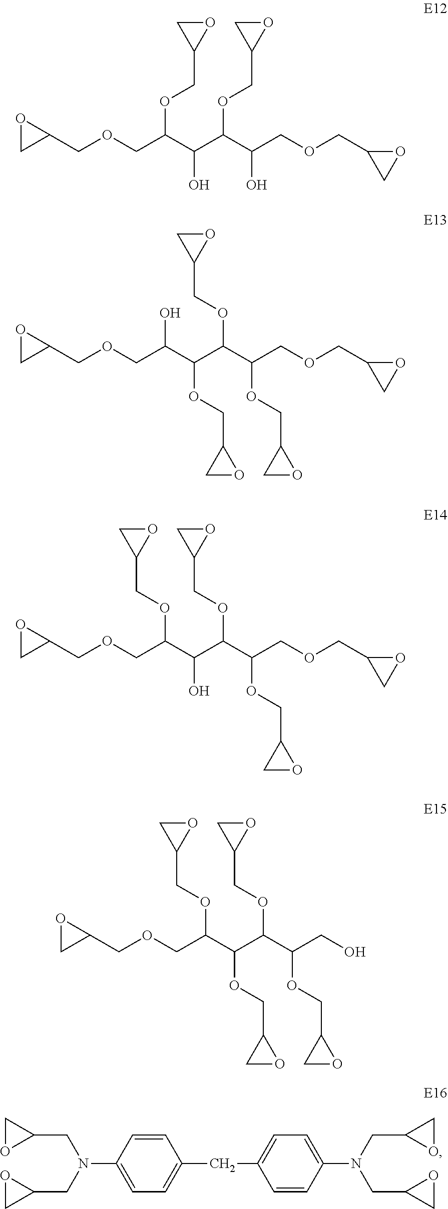 [SMILES: OC(COCC1CO1)C(OCC1CO1)C(O)C(COCC1CO1)OCC1CO1 ; OC(COCC1CO1)C(OCC1CO1)C(OCC1CO1)C(COCC1CO1)OCC1CO1 ; OC(C(COCC1CO1)OCC1CO1)C(OCC1CO1)C(COCC1CO1)OCC1CO1 ; OCC(OCC1CO1)C(OCC1CO1)C(OCC1CO1)C(COCC1CO1)OCC1CO1 ; c1cc(N(CC2CO2)CC2CO2)ccc1Cc1ccc(N(CC2CO2)CC2CO2)cc1]

polymeric forms thereof, or mixtures of two or more thereof;
   b. providing at least one compound of formula (I)

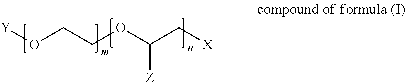

wherein X is selected from hydrogen, C₁-C₁₈ alkyl, C₂-C₁₈ alkenyl or C₇ to C₁₅ arylalkyl;
Z is independently selected from —CH₃, —C₂H₅, —C₃H₇, or —C₆H₆,
m is 5 to 100,
n is 0 to 20,
X is selected from —OC(O)—R—C(O)OH, —NHC(O)—R—C(O)OH or —ORC(O)OH; wherein
R is selected from C₁-C₁₀ alkyl, C₂-C₁₀ alkenyl, C₆-C₁₀ cycloaliphatic or Ce aromatic,
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, or substituted or unsubstituted C₆-C₁₀ aryl;
   c. providing at least one compound (P) having at least one pigment affinic group has at least one active hydrogen to obtain a ternary mixture and
   d. heating the mixture obtained in step c. to a desired temperature to obtain the product.

In another preferred embodiment, presently claimed invention is directed to a process for the preparation of a polymer (D) comprising the steps of:
a. providing at least one epoxide (E) is selected from

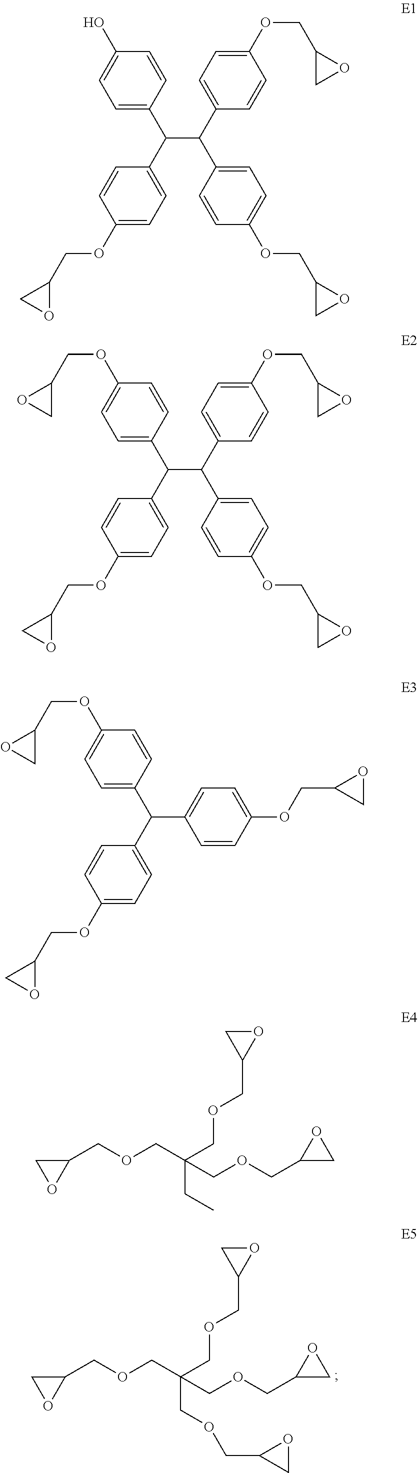

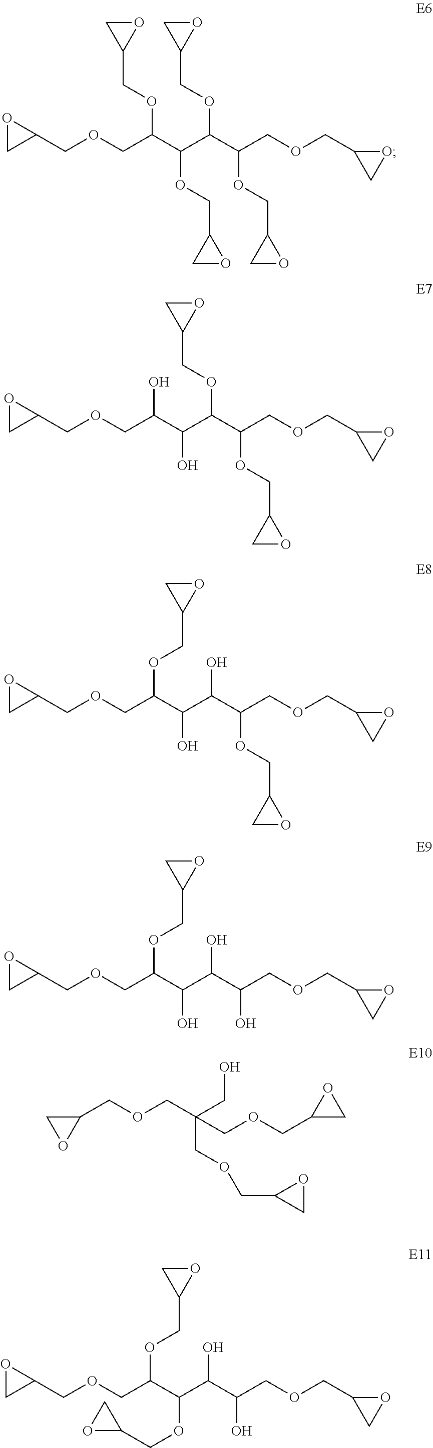

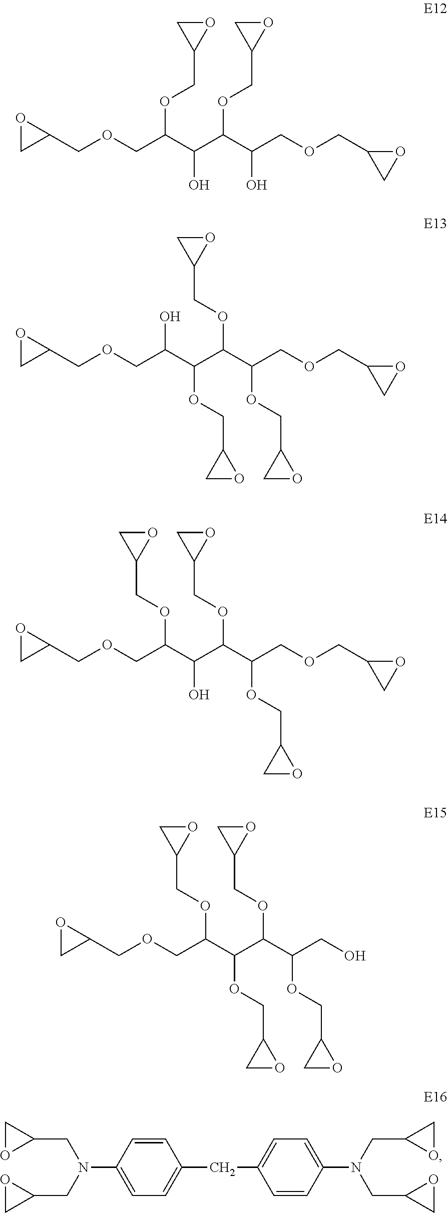 [SMILES: OC(COCC1CO1)C(OCC1CO1)C(O)C(COCC1CO1)OCC1CO1 ; OC(COCC1CO1)C(OCC1CO1)C(OCC1CO1)C(COCC1CO1)OCC1CO1 ; OC(C(COCC1CO1)OCC1CO1)C(OCC1CO1)C(COCC1CO1)OCC1CO1 ; OCC(OCC1CO1)C(OCC1CO1)C(OCC1CO1)C(COCC1CO1)OCC1CO1 ; c1cc(N(CC2CO2)CC2CO2)ccc1Cc1ccc(N(CC2CO2)CC2CO2)cc1]

polymeric forms thereof, or mixtures of two or more thereof;
   b. providing at least one compound of formula (I)

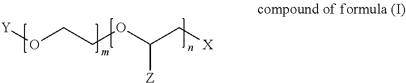

wherein X is selected from hydrogen, C₁-C₁₈ alkyl, C₂-C₁₈ alkenyl or C₇ to C₁₅ arylalkyl;
Z is independently selected from —CH₃, —C₂H₅, —C₃H₇, or —C₆H₆,
m is 5 to 100,
n is 0 to 20,
X is selected from —OC(O)—R—C(O)OH, —NHC(O)—R—C(O)OH or —ORC(O)OH; wherein
R is selected from C₁-C₁₀ alkyl, C₂-C₁₀ alkenyl, C₆-C₁₀ cycloaliphatic or Ce aromatic,
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, or substituted or unsubstituted C₆-C₁₀ aryl;
   c. providing at least two compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

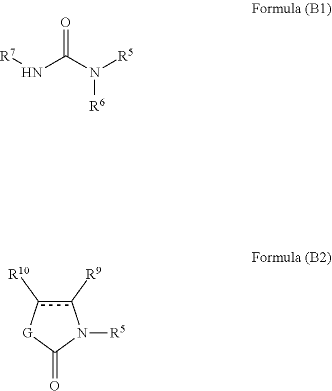

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, —NHR¹¹—, or —SH,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula (C) selected from C(1), C(2), C(3) or C(4),

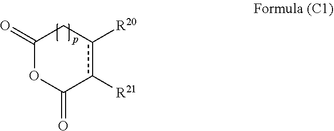

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl,
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
dotted line represents an optional bond, and
p is selected from 0, 1 or 2,

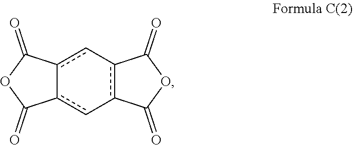

wherein dotted line represents an optional bond,

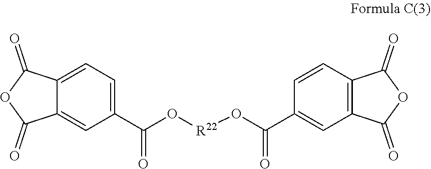

wherein R²² is selected from linear or branched, substituted or unsubstituted C₁-C₂₀ alkylene, linear or branched, substituted or unsubstituted C₂-C₃₀ alkenylene, linear or branched, substituted or unsubstituted C₁-C₂₀ hetero alkylene, substituted or unsubstituted C₆-C₁₀ cycloalkylene or linear or branched, substituted or unsubstituted C₆-C₁₀ arylene,
dotted line represents an optional bond; and

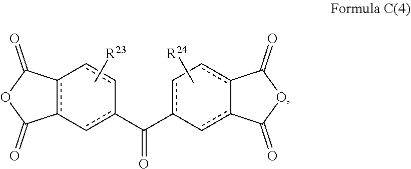

wherein R²³ and R²⁴ independently selected from hydrogen, halogen, —NO₂, SO₃H, or —COOH and dotted line represents an optional bond, or a mixture thereof to obtain a ternary mixture; and
d. heating the mixture obtained in step c. to a desired temperature to obtain the product.

In another embodiment, a person skilled in art may interchange the process of adding each reaction components. It is also envisaged in the presently claimed invention that the epoxide (E) is reacted first with at least one compound of formula (I) to obtain an intermediate and further reacting the intermediate with at least one compound (P) having at least one pigment affinic group has at least one active hydrogen to obtain the dispersant. Similarly, a person skilled in art may first react the epoxide (P) with at least one compound (P) having at least one pigment affinic group has at least one active hydrogen to obtain an intermediate. This intermediate is further reacted with at least one compound of formula (I) to obtain the dispersant.

In another preferred embodiment, the process further comprises a step of adding a catalyst.

In another preferred embodiment, the catalyst is selected form (triethanolatoamine) Ti—O—R₂₀ wherein R₂₀ is a linear or branched (C₁₋₁₂)alkyl), preferably a linear or branched (C₁₋₆)alkyl), such as triethanolatoamine titanium isopropanolate (CAS number 74665-17-1), Zirconium tetrabutanolate (CAS number 1071-76-7), tris(diethylphosphinato)aluminium (CAS number 225789-38-8), Aluminum distearate (CAS number 300-92-5), Dioctyltindilaureate (CAS number 3648-18-81), Titanium tristearate monoisopropanolate, Zinc (II) acetylacetonate, copper (II) acetylacetonate (CAS number: 13395-16-9), titanium diacetylacetonate diisopropanolate (CAS number: 27858-32-8), Titanium (IV) butoxide (CAS number 5593-70-4), Titanium diisopropoxide bis(acetylacetonate) (CAS number 17927-72-9), Titanium isopropoxide (4) (CAS number 546-68-9); Tetrakis(2-ethylhexyl) orthotitanate (CAS number 1070 Oct. 6), Tetrakis(triethanolaminato) zirconium (IV) (CAS number 101033-44-7), Zinc stearate (CAS number 557-05-1), or Boron trifluoride ethylamine complex (CAS number 75-23-0), most preferably the catalyst is Zinc (II) acetylacetonate.

It is known to a person skilled in art the kind of catalyst used in the acid-epoxy reaction and also available in literature. (Reference: waterbome and solvent based epoxies and their end use applications, John Wiley and Sons and SITA technology Ltd. (ISBN 0947798498))

For acid-epoxy reaction the alkaline substances such as tertiary amines, trialkyl phosphines, triphenyl phosphine, quatemary ammonium compounds, quaternary phosphonium compounds, potassium hydroxide, Sodium hydroxide can be used as catalyst. Other catalyst used are organometallic compounds such as Zinc acetylacetonate, Zirconium acetyl acetonate, Zr Octoate, Zinc octoate, Li-Stearate, stannous octoate and for amine epoxy, thiol-epoxy the choice of catalyst is tertiary amine catalyst.

In another preferred embodiment, according to the process, the step d. reaction is carried out at a temperature in the range of 20 to 250° C., more preferably the step d. reaction is carried out at a temperature in the range of 50 to 200° C., even more preferably the step d. reaction is carried out at a temperature in the range of 80 to 180° C., most preferably the step d. reaction is carried out at a temperature in the range of 80 to 150° C., and in particular the step d. reaction is carried out at a temperature in the range of 100 to 140° C.

In another preferred embodiment, the steps a. to d. are conducted in the presence of at least one solvent or in the absence of a solvent.

In another preferred embodiment, the at least one solvent is selected from alcohols, ketones, esters, aromatic solvents, aliphatic solvents, cyclic ethers, ethers, ether alcohols, or mixtures of two or more thereof, more preferably the at least one solvent is selected from ketones, esters, aromatic solvents, aliphatic solvents, cyclic ethers, ethers, or mixtures of two or more thereof, even more preferably the at least one solvent is selected from ketones, esters, cyclic ethers, ethers, or mixtures of two or more thereof, most preferably the at least one solvent is selected from ketones, esters, cyclic ethers or mixtures of two or more thereof and in particular the at least one solvent is selected from ketones, esters, or mixtures of two or more thereof.

In another preferred embodiment, the reaction in step d. is carried out for a time period in the range of 10 minutes to 10 hours, more preferably the reaction in step d. is carried out for a time period in the range of 10 minutes to 8 hours, even more the reaction in step d. is carried out for a time period in the range of 30 minutes to 5 hours, most the reaction in step d. is carried out for a time period in the range of 30 minutes to 3 hours, and in particular the reaction in step d. is carried out for a time period in the range of 30 minutes to 2 hours.

In another preferred embodiment, the presently claimed invention is directed to the use of the polymer (D) described above as a dispersant for particulate solid material.

In another preferred embodiment, the the particulate solid maerial is pigments, more preferably an organic piment.

In another embodiment, the presently claimed invention is directed to a composition in the form of a dispersion comprising,
the polymer (D) as described above; and
at least one particulate solid material selected from pigments or fillers; and
at least one liquid diluent;
more preferably the presently claimed invention is directed to a composition in the form of a dispersion comprising,
   the polymer (D) as described above; and
   at least one particulate solid material selected from pigments or fillers;
   at least one liquid diluent; and
   at least one polymeric binder,
wherein the particulate solid material is dispersed in a liquid diluent selected from organic solvents or water or a mixture from both.

In another preferred embodiment, the binder is selected from, paints, fillers, additives, or mixtures of two or more thereof. The representative examples of additives selected from, but are not limited to, surfactants, light stabilizers, UV-absorbers, anti-foaming agents, dyes, plasticizers, levelling agents, anti-skinning agents or mixtures of two or more thereof. More preferably, the at least one binder is preferably selected from a poly(meth)acrylates, polystyrenics, polyesters, alkyds, polysaccharides, polyurethanes, or mixtures of two or more thereof.

In another preferred embodiment, the composition as described above comprises, the weight ratio of the particulate solid material to the polymer (D) according to presently claimed invention is in the range from 20:1 to 1:20, more preferably the weight ratio of the particulate solid material to the dispersant according to presently claimed invention is in the range from 20:1 to 1:10 and most preferably the weight ratio of the particulate solid material to the dispersant according to presently claimed invention is in the range from 20:1 to 1:5.0.

In another preferred embodiment, the composition as described above comprises
≥1 to ≤70% by weight, based on the total weight of the composition, particulate solid material, selected from pigments or fillers;
≥0.5 to ≤50% by weight, based on the total weight of the composition, of the polymer (D) as described above; and
≥10 to ≤98.5% by weight, based on the total weight of the composition, liquid diluent.

In another preferred embodiment, the composition is in the form of a millbase, or a coating composition.

In another preferred embodiment, the composition is having a particle size (D₅₀) in the range of 10 to 500 nm measured using dynamic light scattering technique, more preferably the composition is having a particle size (D₅₀) in the range of 10 to 300 nm measured using dynamic light scattering technique, even more preferably the composition is having a particle size (D₅₀) in the range of 30 to 250 nm measured using dynamic light scattering technique, most preferably the composition is having a particle size (D₅₀) in the range of 50 to 200 nm measured using dynamic light scattering technique and in particular the composition is having a particle size (D₅₀) in the range of 80 to 175 nm measured using dynamic light scattering technique.

The presently claimed invention is associated with at least one of the following advantages:
Pigment dispersion with submicron particle size can be achieved.
It is possible to tailor the characteristics of the dispersant by altering the type of pigment affinic group, and the number and the length of the compound of formula 1.

### Embodiments

In the following, there is provided a list of embodiments to further illustrate the present disclosure without intending to limit the disclosure to the specific embodiments listed below.
1. A polymer (D) obtained by reacting:
   a. at least one epoxide (E) having an average functionality of ≥3.0 and a number average molar weight in the range of from 250 to 25000 g/mol as determined according to GPC using THE as solvent;
   b. at least one compound (P) having at least one pigment affinic group, wherein the pigment affinic group has at least one active hydrogen reactive to an epoxide group; and
   c. at least one compound of formula (I)

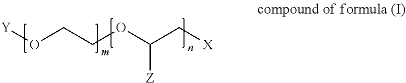

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl.
2. The polymer (D) according to embodiment 1, wherein the epoxide (E) is having an average functionality in the range of 3 to 10.
3. The polymer (D) according any one of the embodiments 1 to 2, wherein the epoxide (E) is having a number average molecular weight in the range of 500 to 10000 g/mol as determined according to GPC using THE as solvent.
4. The polymer (D) according any one of the embodiments 1 to 3, wherein the at least one enoxide (F) is selected from

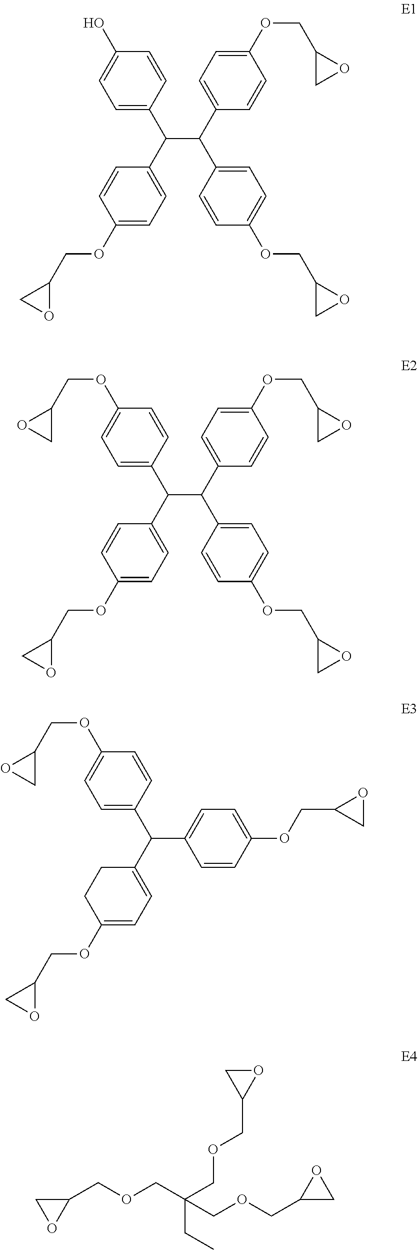 [SMILES: Oc1ccc(C(c2ccc(OCC3CO3)cc2)C(c2ccc(OCC3CO3)cc2)c2ccc(OCC3CO3)cc2)cc1 ; c1cc(C(c2ccc(OCC3CO3)cc2)C(c2ccc(OCC3CO3)cc2)c2ccc(OCC3CO3)cc2)ccc1OCC1CO1 ; C1=C(OCC2CO2)CCC(C(c2ccc(OCC3CO3)cc2)c2ccc(OCC3CO3)cc2)=C1 ; CCC(COCC1CO1)(COCC1CO1)COCC1CO1]

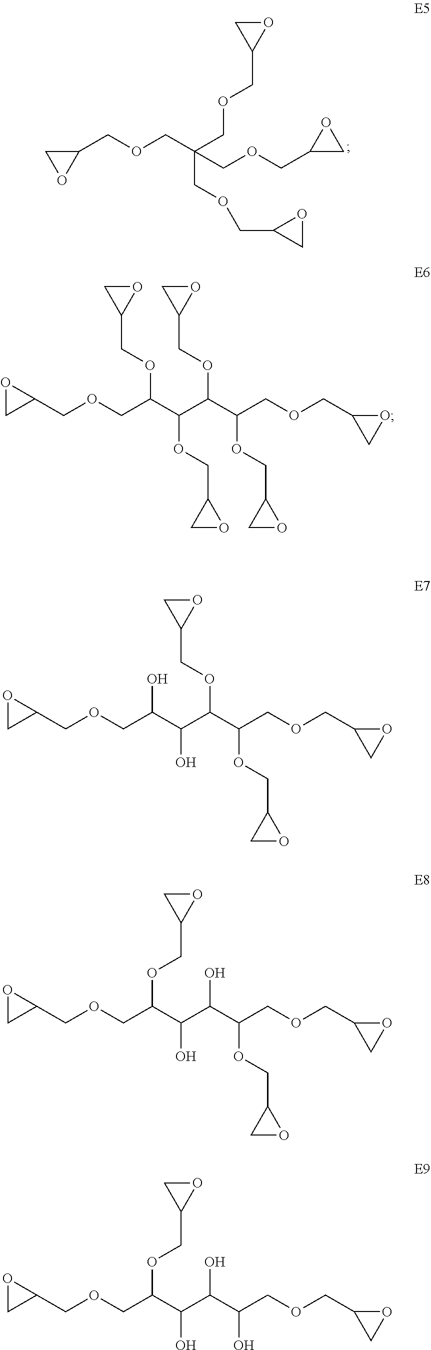 [SMILES: C(OCC(COCC1CO1)(COCC1CO1)COCC1CO1)C1CO1 ; C(OCC(OCC1CO1)C(OCC1CO1)C(OCC1CO1)C(COCC1CO1)OCC1CO1)C1CO1 ; OC(COCC1CO1)C(O)C(OCC1CO1)C(COCC1CO1)OCC1CO1 ; OC(C(COCC1CO1)OCC1CO1)C(O)C(COCC1CO1)OCC1CO1 ; OC(COCC1CO1)C(O)C(O)C(COCC1CO1)OCC1CO1]

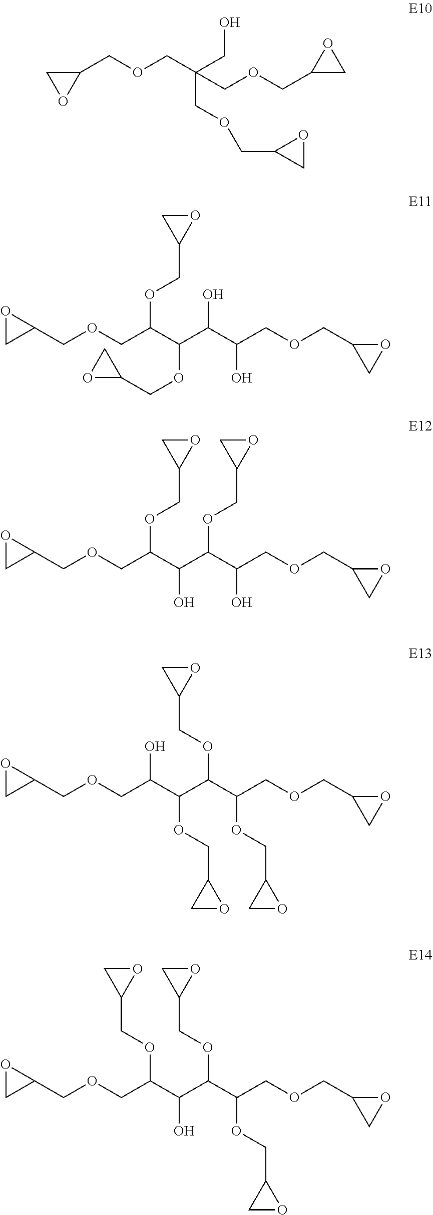 [SMILES: OCC(COCC1CO1)(COCC1CO1)COCC1CO1 ; OC(COCC1CO1)C(O)C(OCC1CO1)C(COCC1CO1)OCC1CO1 ; OC(COCC1CO1)C(OCC1CO1)C(O)C(COCC1CO1)OCC1CO1 ; OC(COCC1CO1)C(OCC1CO1)C(OCC1CO1)C(COCC1CO1)OCC1CO1 ; OC(C(COCC1CO1)OCC1CO1)C(OCC1CO1)C(COCC1CO1)OCC1CO1]

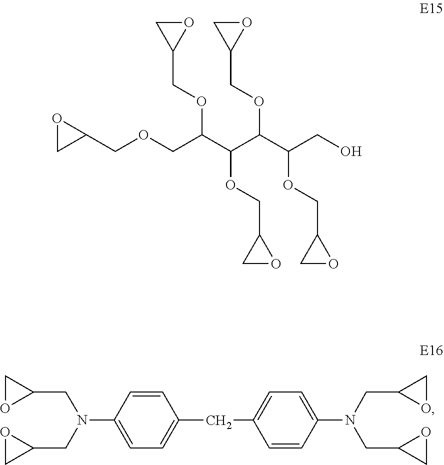 [SMILES: OCC(OCC1CO1)C(OCC1CO1)C(OCC1CO1)C(COCC1CO1)OCC1CO1 ; c1cc(N(CC2CO2)CC2CO2)ccc1Cc1ccc(N(CC2CO2)CC2CO2)cc1]

polymeric forms thereof, or mixtures of two or more thereof.
5. The polymer (D) according to embodiment 4, wherein the at least one epoxide (E) is selected from E1, E2, E3, polymeric forms thereof or mixtures of two or more thereof.
6. The polymer (D) according to embodiment 1, wherein the at least one compound (P) having at least one pigment affinic group has at least one active hydrogen reactive to an epoxide group is selected from diphenolic acid, 3-hydroxynaphthalene-2-carboxylic acid, dialkanolamine, dialkyl amine, dibenzylamine, or a reaction product obtained by reacting at least one compound of formula (B) selected from (B1) or (B2)

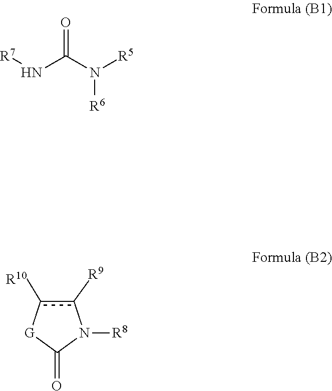

wherein G is selected from —NH—, or —CH₂—;
dotted line represents an optional bond,
R⁵, R⁶, R⁷, R⁸, R⁹ and R¹⁰ independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from O, N or S as ring member(s);
with the proviso that at least one of R⁵, R⁶, R⁷, R⁸, R⁹ or R¹⁰ is substituted with at least one —OH, —NHR¹¹—, or —SH,
R¹¹ is selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl;
   with at least one anhydride of formula (C) selected from C(1), C(2), C(3) or C(4),

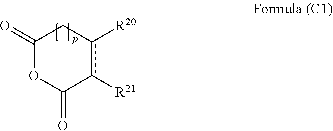

wherein R²⁰ and R²¹ are independently selected from hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, or substituted or unsubstituted C₆-C₁₀ aryl,
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from O, N or S as ring member(s);
dotted line represents an optional bond, and
p is selected from 0, 1 or 2,

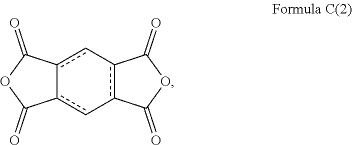

wherein dotted line represents an optional bond,

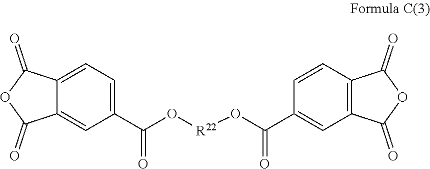

wherein R²² is selected from linear or branched, substituted or unsubstituted C₁-C₂₀ alkylene, linear or branched, substituted or unsubstituted C₂-C₃₀ alkenylene, linear or branched, substituted or unsubstituted C₁-C₂₀ hetero alkylene, substituted or unsubstituted C₆-C₁₀ cycloalkylene or linear or branched, substituted or unsubstituted C₆-C₁₀ arylene,
dotted line represents an optional bond; and

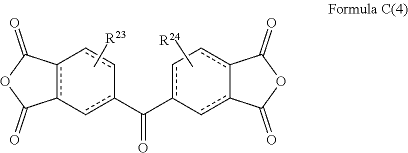

wherein R²³ and R²⁴ independently selected from hydrogen, halogen, —NO₂, SO₃H, or —COOH and
dotted line represents an optional bond,
or mixtures of two or more thereof.
7. The polymer (D) according to embodiment 6, wherein the at least one compound (P) having at least one pigment affinic group has at least one active hydrogen is a reaction product obtained by reacting N-(2-hydroxyethyl) ethylene urea with at least one anhydride of formula (C₁).
8. The polymer (D) according to any one of the embodiments 6 to 7, wherein the at least one anhydride is selected from

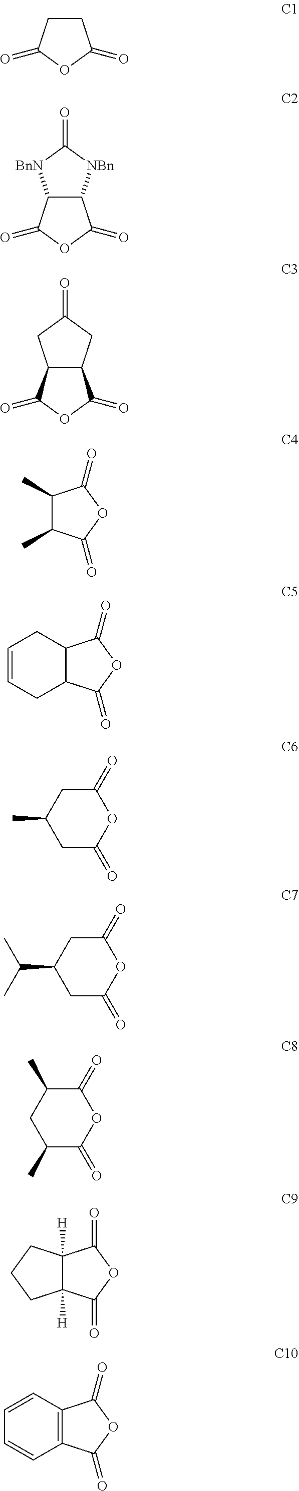

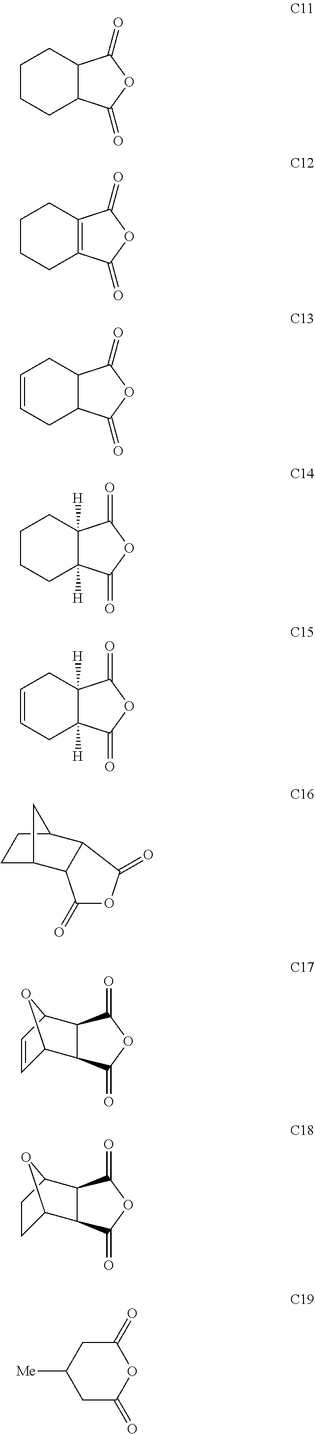

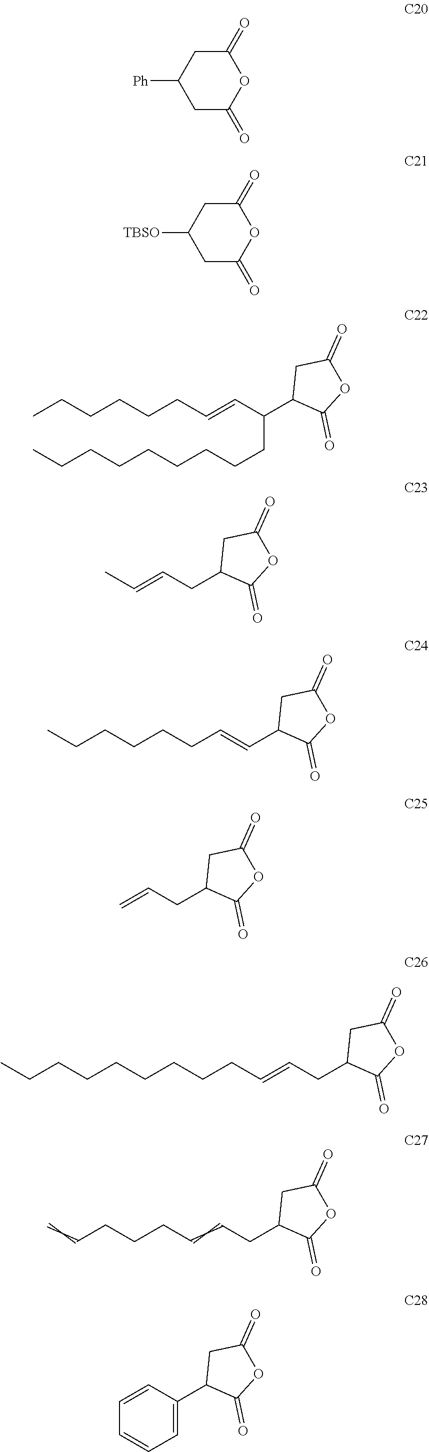

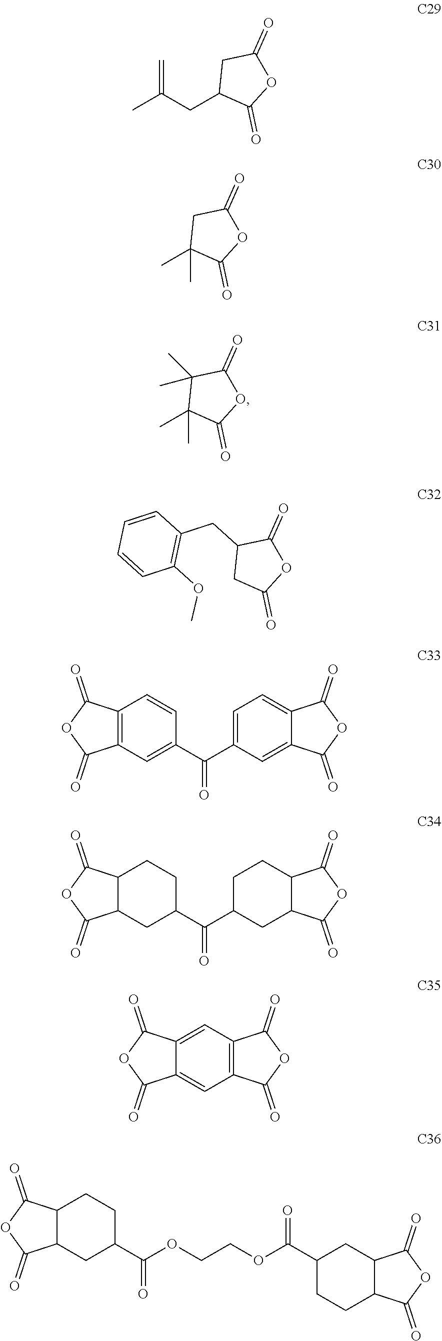

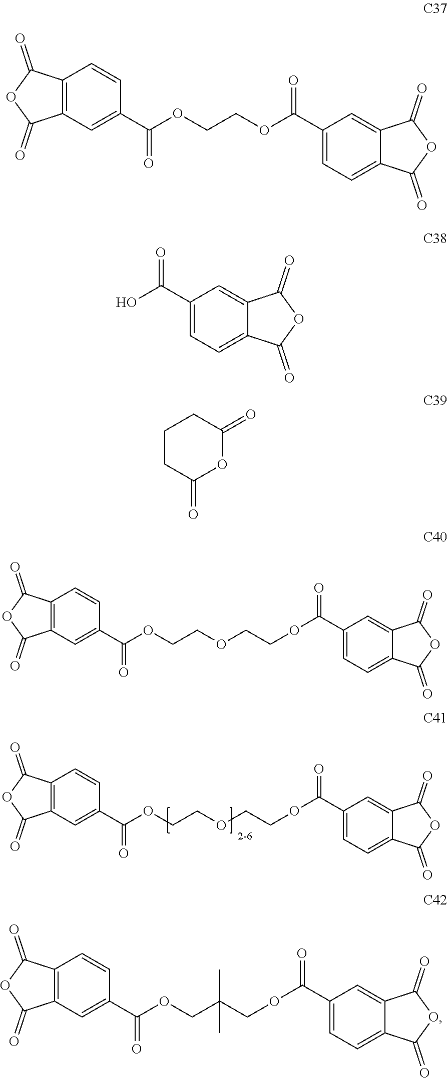

or mixture of two or more thereof.
9. The polymer (D) according to any of one of the embodiments 1 to 8, wherein the at least one compound of formula (I) is

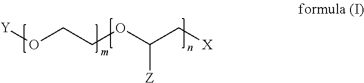

wherein X is selected from hydrogen, C₁-C₁₈ alkyl, C₂-C₁₈ alkenyl or C₇ to C₁₅ arylalkyl;
Z is independently selected from —CH₃, —C₂H₅, —C₃H₇, or —C₆H₆,
m is 5 to 100,
n is 0 to 20,
X is selected from —OC(O)—R—C(O)OH, —NHC(O)—R—C(O)OH or —ORC(O)OH; wherein
R is selected from C₁-C₁₀ alkyl, C₂-C₁₀ alkenyl, C₆-C₁₀ cycloaliphatic or C₆ aromatic,
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, or substituted or unsubstituted C₆-C₁₀ aryl.
10. The polymer (D) according to any one of the embodiments 1 to 9, wherein the compound of formula (I) is a random copolymer or a block copolymer and comprises at least 50 wt. % of ethylene oxide in polymerized form based on overall weight of compound of formula (I).
11. The polymer (D) according to embodiment 10, wherein the compound of formula (I) is a random copolymer or a block copolymer and comprises ethylene oxide in polymerized from in the range of 50 to 100 wt. % based on overall weight of compound of formula (I).
12. The polymer (D) according to embodiment 10, wherein the compound of formula (I) is a random copolymer or a block copolymer and having ethylene oxide in the range of 50 to 100 wt. % and propylene oxide in the range of 0 to 50 wt. %, each based on overall weight of compound of formula (I).
13. The polymer (D) according to any one of the embodiments 1 to embodiment 12, wherein the mol ratio of at least one epoxide (E) to at least one compound (P) is the range of 0.25 to 0.90.
14. The polymer (D) according to any one of the embodiments 1 to embodiment 13, wherein the mol ratio of at least one epoxide (E) to compound of formula (I) is the range of 0.10 to 0.75.
15. The polymer (D) according to any one of the embodiments 1 to embodiment 14 having a number average molecular weight in the range of 2000 to 100000 g/mol as measured using GPC using THF or chloroform as solvent.
16. The polymer (D) according to embodiment 15 having a number average molecular weight in the range of 10000 to 50000 g/mol as measured using GPC using THE as solvent.
17. A process for the preparation of a polymer (D) according to any one of the embodiments 1 to 16 comprising the steps of:
   a. providing at least one epoxide (E) having an average functionality of ≥3.0 and a number average molar weight in the range of from 250 to 25000 g/mol as determined according to GPC using THE as solvent;
   b. providing at least one compound of formula (I)

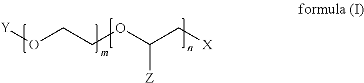

wherein Y is selected from hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl or substituted or unsubstituted C₆-C₁₀ aryl
Z is selected from C₁-C₆ alkyl or C₆-C₁₀ aryl,
m is 5 to 500,
n is 0 to 100,
X is selected from —OC(O)—R—C(O)OH, —NR¹C(O)—R—C(O)OH, —ORC(O)OH, —OC(O)—R—SH, —NHR¹ or —O—R—SH;
wherein R is selected from linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, or substituted or unsubstituted C₆-C₁₀ arylene, and
R¹ is selected from hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, or substituted or unsubstituted C₆-C₁₀ arylalkyl to obtain a mixture;
   c. providing at least one compound (P) having at least one pigment affinic group has at least one active hydrogen to obtain a ternary mixture and
   d. heating the mixture obtained in step c. to a desired temperature to obtain the product.
18. The process according to embodiment 17, wherein in the step d. reaction is carried out at a temperature in the range of 20 to 250° C. (preferred 100 to 140° C.)
19. The process according to any one of the embodiments 17 to 18, wherein the steps a. to d. are conducted in the presence of at least one solvent or in the absence of a solvent.
20. The process according to embodiment 19, wherein the at least one solvent is selected from alcohols, ketones, esters, aromatic solvents, aliphatic solvents, cyclic ethers, ethers, ether alcohols or mixtures of two or more thereof.
21. The process according to any one of the embodiments 16 to 20, wherein the reaction in step d. is carried out for a time period in the range of 10 minutes to 10 hours.
22. Use of a polymer (D) according to any one of the embodiments 1 to 16 as a dispersant for particulate solid material.
23. The use according to embodiment 22, wherein the particulate solid maerial is pigments.
24. A composition in the form of a dispersion comprising,
   a. the polymer (D) according to any one of the embodiments 1 to 16; and
   b. at least one particulate solid material selected from pigments or fillers;
   c. at least one liquid diluent, and
   d. at least one polymeric binder,
      wherein the particulate solid material is dispersed in a liquid diluent selected from organic solvents or water or mixture from both;
25. The composition according to embodiment 24, wherein the weight ratio of the particulate solid material to the polymer (D) according to any one of the embodiments 1 to 16 is in the range from 20:1 to 1:20. ((100 part pigment 5 part dispersant) to (100 part pigment to 500 part dispersant))
26. The composition according to any of the embodiments 24 or 25, comprising
   a) ≥1 to ≤70% by weight, based on the total weight of the composition, particulate solid material, selected from pigments or fillers;
   b) ≥0.5 to ≤50% by weight, based on the total weight of the composition, of the polymer (D) according to any one of the embodiments 1 to 16; and
   c) ≥10 to ≤98.5% by weight, based on the total weight of the composition, liquid diluent.
27. The composition according to any one of the embodiments 24 to 26, which is in the form of a millbase, or a coating composition.
28. The composition according to any one of the embodiments 24 to 27 having a particle size (D₅₀) in the range of 10 to 500 nm measured using dynamic light scattering technique.

### EXAMPLES

The presently claimed invention is illustrated in detail by non-restrictive working examples which follow. More particularly, the test methods specified hereinafter are part of the general disclosure of the application and are not restricted to the specific working examples.

### Materials and Method

1-(2-hydroxyethyl)-2-imidazolidinone, available as SR512 from Sartomer USA.

Succinic anhydride is available from Sigma Aldrich.

Poly(ethyleneglycol) methyl ether (MPEG-2K) was obtained from Clariant (Polyglykol M 2000). Glycidyl ether of 1,1,2,2-tetrakis(p-hydroxyphenyl) ethane is available as Epokukdo KDT-4400 from Kukdo Chemical.

4,4-bis(4-hydroxyphenyl) valeric acid is available from Sigma Aldrich.

Paliogen® Maroon L 3920, BASF Perrindo® Maroon 179 229-8801, Sun Chemicals

### Preparation of Intermediate 1 (P)

Molten 1-(2-hydroxyethyl)-2-imidazolodinone (38.64 g) was charged to three neck flask equipped with stirrer, thermocouple and nitrogen inlet flask to which succinic anhydride (29.71 g) was charged. The mixture was reacted at 100 to 105° C. until the anhydride had been reacted completely as monitored by FTIR, to obtain the compound the pigment affinic group (P).

### Preparation of Intermediate 2 (Compound of Formula I)

Poly(ethylene glycol) methyl ether having average molecular weight (Mw) of 2000 (447.5 g) was reacted with succinic anhydride (25.92 g) at 120° C. for 2.5 to obtain the intermediate 2.

### Synthesis Example 2 (C51)

To a 4-neck flask equipped with stirrer, water cooled condenser and nitrogen inlet, molten Intermediate 2 (167.6 g) and 1.66 g Zinc acetyl acetonate was charged and under stirring, Glycidyl ether of 1,1,2,2-tetrakis(p-hydroxyphenyl) ethane (KDT-4400 (47.6 g)) and 25 g methyl isobutyl ketone was added and heated to 115° C. Then intermediate 1 (6.66 g) was charged and reacted at 110-111° C. for 40 min followed by addition of 4,4-Bis(4-hydroxyphenyl) valeric acid (23.2 g) and methyl ethyl ketone (5 g). The reaction was carried out at 120-125° C. temperature till desired reaction completion as confirmed by monitoring epoxy equivalent weight to be >13000 g/eq. The processing solvent was distilled out during this process. Heating was stopped and the polymer was diluted by methyl ethyl ketone (80 g) and propylene glycol n-propyl ether (20 g) to homogeneous solution. The product was obtained as a medium viscosity dark yellowish amber colored clear solution with a % nonvolatile matter of 70.0% (110° C. for 1 hour).

### Synthesis Example 3 (C78)

To a 4-neck flask equipped with stirrer, water cooled condenser and nitrogen inlet, molten Intermediate 2 (215.1 g) and KDT-4400 (47.58 g) was charged and heated to 85° C. then 1.96 g of Benzyltrimethylammonium hydroxide solution (40% in methanol) is added and further heated to 120° C. After 1 hr at 120° C., 4,4-Bis(4-hydroxyphenyl) valeric acid (40.4 g) and methyl ethyl ketone (10 g) was charged. The reaction was carried out at 120-125° C. temperature till reaction completion as confirmed by monitoring epoxy equivalent weight of >20000 g/eq. The processing solvent was distilled out during this process. Heating was stopped and the polymer was diluted by methyl ethyl ketone (104 g) and propylene glycol n-propyl ether (26 g) to homogeneous solution. The product was obtained as a medium viscosity dark yellowish amber colored clear solution with a % nonvolatile matter of 69.9% (110° C. for 1 hour).

### Synthesis Example 4 (C79)

To a 4-neck flask equipped with stirrer, water cooled condenser and nitrogen inlet, molten Intermediate 2 (175.7 g) and KDT-4400 (48.8 g) was charged and heated to 85° C. then 1.4 g of Benzyltrimethylammonium hydroxide solution (40% in methanol) is added and further heated to 120° C. After 20 min Intermediate 1 (26.5 g) was charged. The reaction was carried out further at 120-125° C. temperature till completion of desired reaction as confirmed by monitoring epoxy equivalent weight to be >20000 g/eq. The processing solvent was distilled out during this process. Heating was stopped and the polymer was diluted by methyl ethyl ketone (104 g) and propylene glycol n-propyl ether (26 g) to homogeneous solution. The product was obtained as a medium viscosity dark yellowish amber colored clear solution with a % nonvolatile matter of 69.7% (110° C. for 1 hour).

### Synthesis Example 5 (C80)

To a 4-neck flask equipped with stirrer, water cooled condenser and nitrogen inlet, molten Intermediate 2 (217.7 g) and KDT-4400 (59.4 g) was charged and heated to 85° C. then 1.85 g of Benzyltrimethylammonium hydroxide solution (40% in methanol) is added and further heated to 120° C. and Intermediate 1 (17.1 g) was charged. After 30 min at 125° C., 4,4-Bis(4-hydroxyphenyl) valeric acid (21.3 g) was chargedand the reaction was carried out further at 125-127° C. temperature till completion of desired reaction as confirmed by monitoring epoxy equivalent weight to be >20000 g/eq. Heating was stopped and the polymer was diluted by methyl ethyl ketone (104 g) and propylene glycol n-propyl ether (26 g) to homogeneous solution. The product was obtained as a medium viscosity dark yellowish amber colored clear solution with a % nonvolatile matter of 69.2% (110° C. for 1 hour).

### Synthesis Example 6 (C87)

To a 4-neck flask equipped with stirrer, water cooled condenser and nitrogen inlet, molten Intermediate 1 (43.1 g) and Intermediate 2 (164.5 g) was charged and heated to 85° C. then 1.4 g of Benzyltrimethylammonium hydroxide solution (40% in methanol) is added and further heated to 105° C. KDT-4400 (59.4 g) was charged and the reaction mass further heated to 125° C. The reaction was carried out further at 125-127° C. temperature till completion of desired reaction as confirmed by monitoring epoxy equivalent weight to be >20000 g/eq. Heating was stopped and the polymer was diluted by methyl ethyl ketone (152 g) and propylene glycol n-propyl ether (26 g) to homogeneous solution. The product was obtained as a medium viscosity dark yellowish amber colored clear solution with a % nonvolatile matter of 62.2% (110° C. for 1 hour).

### Preparation of Pigment Dispersion:

Pigment Red 179 (PR179) and Pigment Violet 29 (PR 29), separately, were dispersed in deionized water, using the inventive dispersant (C₅₁) and comparative dispersant D₁, with the help of Vibroshaker as grinding equipment. The dispersion process was carried out in two stage with different types of grinding media; 4 hours using 0.8 mm Yttria-stabilized zirconia bead followed by 4 hours using 0.3 mm Yttria-stabilized zirconia bead. The ratio of grinding media to mill base was 2:1 (w/w). The composition of mill base is disclosed in table 1. The dispersion was filtered after each stage to change grinding media. The pigment loading was 10% by weight in total formulation. The particle size (D₅₀) of the obtained pigment dispersion is disclosed in Table 2.

### Grinding

Waterborne pigment pastes were milled on a Lau Disperser-Model DAS H-TP 200-K with cooling system (LAU GmbH, Hemer, Germany) unless otherwise stated. To each formulation shaken on a Lau Disperser, 0.3 mm yttria-stabilized zirconia beads (Fox Industries, Fairfield, New Jersey, USA) were added in order to grind the pigment. For waterborne systems, the beads were ˜200% of the total formulation weight, for example 100 g of formulation was added to 200 g of beads to make a total of 300 g. The prepped sample was then placed on the Lau Disperser-Model DAS H-TP 200-K with cooling system (LAU GmbH, Hemer, Germany) and shaken with the fan on for 540 minutes or 9 hours. Upon completion of the run, the samples were filtered to remove the beads and stored in aluminium paint cans. Filtered beads were washed with solvent and reused.

All formulation examples used 40% resin solids by weight with reference to pigment solids and all formulations were prepared at 10% by weight of pigment. Example 9 was prepared by milling a pigment paste on a DCP-12 superflow mill (Draiswerke GmbH, Mannheim Germany) using a commercially-available grinding resin 350CD0001 (BASF Corp. at 26701 Telegraph Rd. Southfield, MI 48033) and Parodur EL 48.6 (BASF) milled with 0.3 mm yttria-stabilized zirconia beads (Fox Industries, Fairfield, New Jersey, USA). The composition of the mill base is disclosed in Tables 3 and 4.

### Colour Evaluation

The waterborne pigment dispersions of perylene red Paliogen Maroon L3920 (BASF SE) and Perrindo Maroon 229-8801 (Sun Chemical), were evaluated for colour performance in non-tinted and tinted formulations, prepared according to customer formulation guidelines, of a General Motors (GM) waterborne base coat, a commercially available 1 component base coat from BASF Corp. at 26701 Telegraph Rd. Southfield, MI 48033. Pigment was added to the non-tinted or tinted basecoat under agitation and the pH of the basecoat was adjusted to 8.1 using N, N-dimethylethanolamine (BASF, Geismar, Louisiana, USA) as a 20 wt. % solution in water. pH was measured using a Starter 300 pH Portable PH meter (Ohaus Corporation, Parsippany, New Jersey, USA). A 100 μm gap on the Byk drawdown bar was used (Byk-Chemie GmbH, Wesel, Germany) to generate a film on melinex drawdown sheets (Puetz GmbH+CO. Folien KG, Taunusstein, Germany) and allowed to flash for ˜20 minutes. The sample was subsequently baked for 30 minutes at 270° F.

Once the sample cooled, the colour spectrum was measured using a Byk Mac i spectrophotometer (Byk-Chemie GmbH, Wesel, Germany). The melinex card with the basecoat drawdown was placed on top of a reflective mirror where the basecoat drawdown is adjacent to the mirror surface. The Byk Mac i is then placed on top of the melinex card and mirror and colour data of the basecoat is measured through the melinex film with d65 light at 15, 25, 45, 75, and 110 degrees off specular using GM CieLab weightings. Measurements were done five times per sample, the data for these measurements is shown in Table 5.

Sprayed panels were prepared by spraying a stainless steel panel, previously coated with a primer layer, with a tinted waterborne basecoat, followed by a flashing step and finally sprayed with a commercially-available 2-component clearcoat (BASF Corp. at 26701 Telegraph Rd. Southfield, MI 48033) and baked at 265° F. for ˜25 minutes. Colour analysis for the sprayed panels is shown in Table 6

This method is used because higher particle size pigment agglomerates result in more scattered light which increases the measured lightness values of the film. As the 110° angle has the longest film path length, it is the most sensitive to detecting increases in scattering. Therefore, L values (lightness) at the 110° angle were used for evaluation and dispersions yielding lower values are more transparent and better.

TABLE 1
composition of pigment dispersion.

| | | Composition parameter | | |
|---|---|---|---|---|
| Pigment | Dispersant | | % pigment in | |
| dispersion | used | Pigment | dispersion | *D/P |
| R-C51-1 | C51 | PR 179 | 10 | 0.5 |
| V-C51-1 | C51 | PV 29 | 10 | 0.5 |
| R-D1-1 | D1 | PR 179 | 10 | 0.75 |
| V-D1-1 | D1 | PV 29 | 10 | 0.75 |

*D/P = solid dispersion to pigment ratio on weight basis.

The particle size of the above composition was measured using digital light scattering technique (Desia nano C particle size analyzer).

TABLE 2
particle size of dispersant-pigment composition
(D₅₀ measured using dynamic
light scattering technique).

| Pigment dispersion code | D₅₀ (nm) |
|---|---|
| R-C51-1 | 126 |
| V-C51-1 | 107 |
| R-D1-1 | 151 |
| V-D1-1 | 132 |

It is evident from table 2 that the dispersant according to presently claimed invention is able to produce pigment dispersion in submicron particle size which is smaller than comparative example at lower loading.

TABLE 3
Experimental WB Dispersion Formulations

| Dispersant | C1 | A1 | A2 | A3 | A4 | A5 |
|---|---|---|---|---|---|---|
| D1 | 11.27 | | | | | |
| C51 | | 5.72 | | | | |
| C78 | | | 1.43 | 2.86 | | |
| C79 | | | 4.31 | 2.87 | 5.74 | |
| C87 | | | | | | 6.42* |
| C80 | | | | | | |
| PARODUR EL | 14.82 | 14.82 | | | | |
| 48.6 | | | | | | |
| Pigment L3920 | 10 | 10 | 10 | 10 | 10 | 10 |
| Propylene glycol | 2.5 | 2.5 | 2.5 | 2.5 | 2.5 | 2.5 |
| n-butyl ether | | | | | | |
| Water | 61.41 | 66.96 | 81.76 | 81.77 | 81.76 | 81.08 |
| total | 100 | 100 | 100 | 100 | 100 | 100 |

TABLE 4
Experimental WB Dispersion Formulations

| Dispersant | C3 | A6 | A7 |
|---|---|---|---|
| D1 | 11.27 | | |
| C87 | | 4.27* | |
| C80 | | | 5.78 |
| Pigment 229-8801 | 10 | 10 | 10 |
| Propylene glycol n-butyl ether | 2.5 | 2.5 | 2.5 |
| Water | 76.23 | 83.23 | 81.72 |
| total | 100 | 100 | 100 |

*40% solid resin content with respect to pigment solids maintained. Different batches of resin have different solids content

TABLE 5
WB Basecoat Evaluations over Melinex Drawdowns

| Dispersant | L at 110° | Weighted dL (110°) |
|---|---|---|
| C1 | 6.5 | — |
| A1 | 6.2 | −0.45 |
| A2 | 6.46 | −0.06 |
| A3 | 6.3 | −0.29 |
| A4 | 6.31 | −0.28 |
| C3 | 10.05 | — |
| A6 | 8.33 | −2.32 |
| A7 | 9.61 | −0.57 |

C1 is comparative for A1, A2, A3 and A4. C3 is comparative for A6 and A7.

TABLE 6
WB Basecoat Evaluations in Sprayed Panels

| Dispersant | L at 110° | Weighted dL (110°) |
|---|---|---|
| C1 | 4.86 | — |
| A5 | 4.49 | −0.61 |

It is evident from the tables 5 and 6 that the dispersant according to presently claimed invention displayed excellent value on formulation having WB Basecoat on Melinex Drawdowns and on Sprayed Panels.

1. A polymer (D) obtained by reacting:
a. at least one epoxide (E) having an average functionality of ≥3.0 and a number average molar weight in a range of from 250 to 25000 g/mol as determined according to GPC using THF as solvent;
b. at least one compound (P) having at least one pigment affinic group, wherein the pigment affinic group has at least one active hydrogen reactive to an epoxide group; and
c. at least one compound of formula (I) 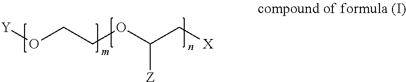
wherein Y is selected from the group consisting of hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl, and substituted or unsubstituted C₆-C₁₀ aryl;
Z is selected from the group consisting of C₁-C₆ alkyl and C₆-C₁₀ aryl,
m is in a range of from 5 to 500,
n is in a range of from 0 to 100,
X is selected from the group consisting of —OC(O)—R—C(O)OH, —NR¹C(O)—R—C(O)OH, —ORC(O)OH, —OC(O)—R—SH, —NHR¹ and —O—R—SH;
wherein R is selected from the group consisting of linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, and substituted or unsubstituted C₆-C₁₀ arylene, and
R¹ is selected from the group consisting of hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, and substituted or unsubstituted C₆-C₁₀ arylalkyl.

2. The polymer (D) according to claim 1, wherein the epoxide (E) has an average functionality in a range of from 3 to 10.

3. The polymer (D) according to claim 1, wherein the at least one epoxide (E) is selected from the group consisting of 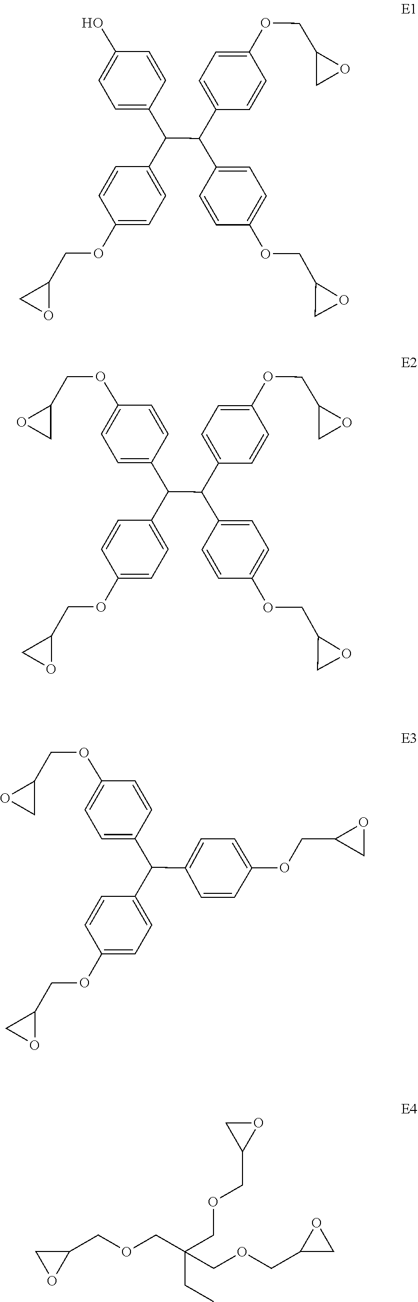 [SMILES: Oc1ccc(C(c2ccc(OCC3CO3)cc2)C(c2ccc(OCC3CO3)cc2)c2ccc(OCC3CO3)cc2)cc1 ; c1cc(C(c2ccc(OCC3CO3)cc2)C(c2ccc(OCC3CO3)cc2)c2ccc(OCC3CO3)cc2)ccc1OCC1CO1 ; c1cc(C(c2ccc(OCC3CO3)cc2)c2ccc(OCC3CO3)cc2)ccc1OCC1CO1 ; CCC(COCC1CO1)(COCC1CO1)COCC1CO1] 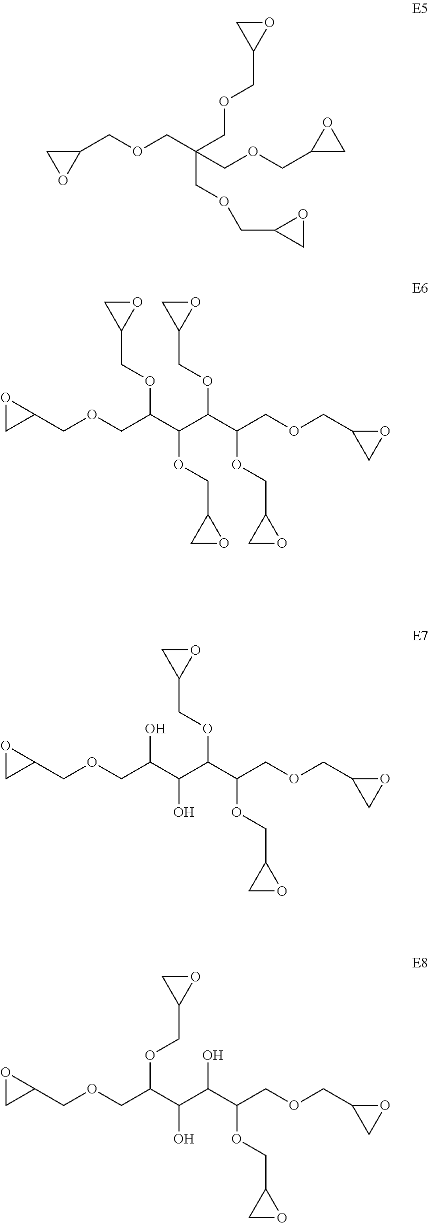 [SMILES: C(OCC(COCC1CO1)(COCC1CO1)COCC1CO1)C1CO1 ; C(OCC(OCC1CO1)C(OCC1CO1)C(OCC1CO1)C(COCC1CO1)OCC1CO1)C1CO1 ; OC(COCC1CO1)C(O)C(OCC1CO1)C(COCC1CO1)OCC1CO1 ; OC(C(COCC1CO1)OCC1CO1)C(O)C(COCC1CO1)OCC1CO1] 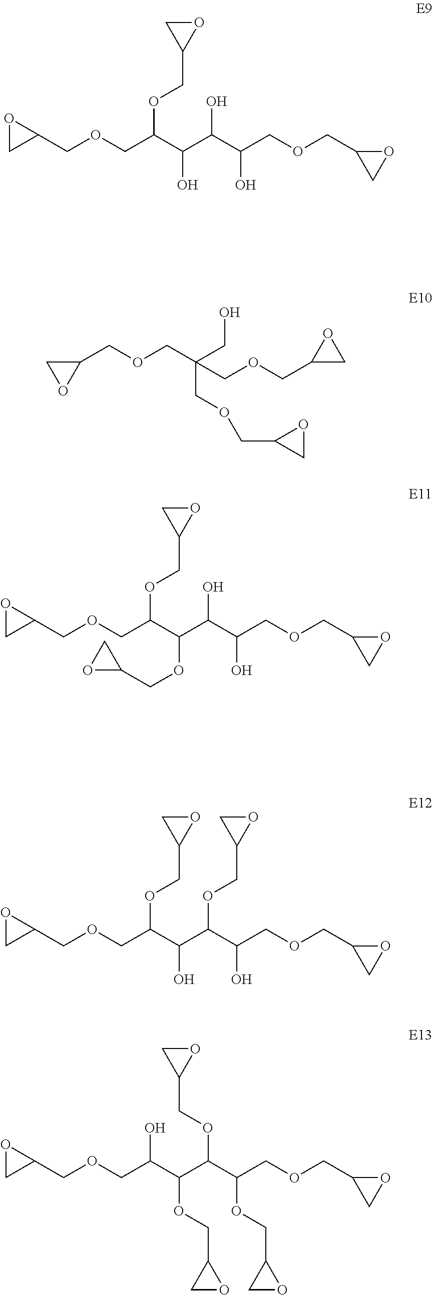 [SMILES: OC(COCC1CO1)C(O)C(O)C(COCC1CO1)OCC1CO1 ; OCC(COCC1CO1)(COCC1CO1)COCC1CO1 ; OC(COCC1CO1)C(O)C(OCC1CO1)C(COCC1CO1)OCC1CO1 ; OC(COCC1CO1)C(OCC1CO1)C(O)C(COCC1CO1)OCC1CO1 ; OC(COCC1CO1)C(OCC1CO1)C(OCC1CO1)C(COCC1CO1)OCC1CO1] 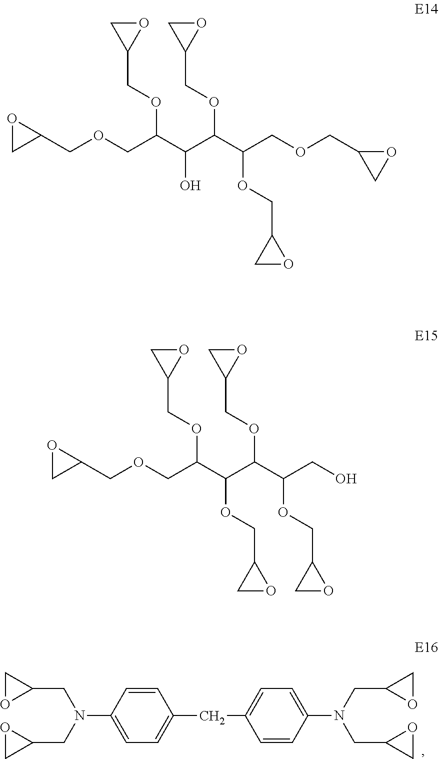 [SMILES: OC(C(COCC1CO1)OCC1CO1)C(OCC1CO1)C(COCC1CO1)OCC1CO1 ; OCC(OCC1CO1)C(OCC1CO1)C(OCC1CO1)C(COCC1CO1)OCC1CO1 ; c1cc(N(CC2CO2)CC2CO2)ccc1Cc1ccc(N(CC2CO2)CC2CO2)cc1]
polymeric forms thereof, and mixtures of two or more thereof.

4. The polymer (D) according to claim 3, wherein at least one compound (P) having at least one pigment affinic group has at least one active hydrogen reactive to an epoxide group and is selected from the group consisting of diphenolic acid, 3-hydroxynaphthalene-2-carboxylic acid, dialkanolamine, dialkyl amine, dibenzylamine, and a reaction product obtained by reacting at least one compound of formula (B) selected from the group consisting of (B1) and (B2) 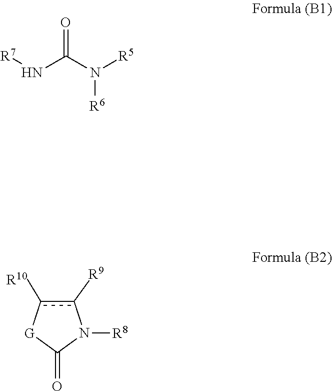
wherein G is selected from the group consisting of —NH— and —CH₂—;
dotted line represents an optional bond,
R⁵, R⁶, R⁷, R⁸, R⁹ and R¹⁰ are independently selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, and substituted or unsubstituted C₆-C₁₀ aryl, or
R⁵, and R⁶ together with the carbon atoms to which they are bonded or
R⁹, and R¹⁰ together with the carbon atoms to which they are bonded or
R⁶, and R⁷ together with the carbon atoms to which they are bonded form substituted or unsubstituted, unsaturated or aromatic 5- to 20-membered carbocyclic ring that optionally contains 1, 2 or 3 heteroatom(s) selected from the group consisting of O, N and S as ring member(s);
R¹¹ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, and substituted or unsubstituted C₆-C₁₀ aryl;
with the proviso that at least one of R⁵, R⁶, R⁷, R⁸, R⁹ or R¹⁰ is substituted with at least one —OH, —NHR¹¹—, -or —SH,
R¹¹ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, and substituted or unsubstituted C₆-C₁₀ aryl;
with at least one anhydride of formula (C) selected from the group consisting of C(1), C(2), C(3) and C(4), 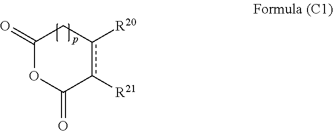
wherein R²⁰ and R²¹ are independently selected from the group consisting of hydrogen, linear or branched, substituted or unsubstituted C₁-C₃₀ alkyl, linear or branched, substituted or unsubstituted C₂-C₃₀ alkenyl, substituted or unsubstituted C₅-C₂₄ cycloalkyl, substituted or unsubstituted C₅-C₂₄ cycloalkenyl, linear or branched, substituted or unsubstituted C₇ to C₁₅ arylalkyl, and substituted or unsubstituted C₆-C₁₀ aryl,
R²⁰ and R²¹ together with the carbon atoms to which they are bonded form substituted or unsubstituted unsaturated or aromatic 5- to 20-membered carbocyclic ring that optionally contains 1, 2 or 3 heteroatom(s) selected from the group consisting of O, N and S as ring member(s);
dotted line represents an optional bond, and
p is selected from the group consisting of 0, 1 and 2, 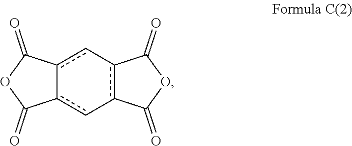
wherein dotted line represents an optional bond, 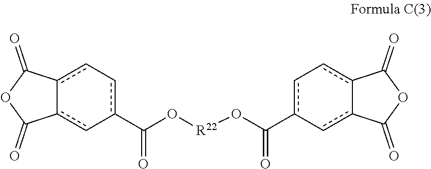
wherein R²² is selected from the group consisting of linear or branched, substituted or unsubstituted C₁-C₂₀ alkylene, linear or branched, substituted or unsubstituted C₂-C₃₀ alkenylene, linear or branched, substituted or unsubstituted C₁-C₂₀ hetero alkylene, substituted or unsubstituted C₆-C₁₀ cycloalkylene or linear or branched, and substituted or unsubstituted C₆-C₁₀ arylene,
dotted line represents an optional bond; and 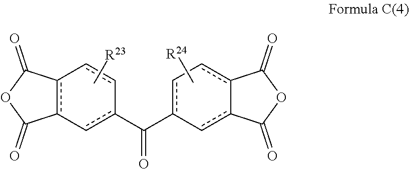
wherein R²³ and R²⁴ are independently selected from the group consisting of hydrogen, halogen, —NO₂, SO₃H, —COOH and
a mixture of two or more thereof, wherein a dotted line represents an optional bond.

5. The polymer (D) according to claim 4, wherein the at least one anhydride is selected from the following compounds 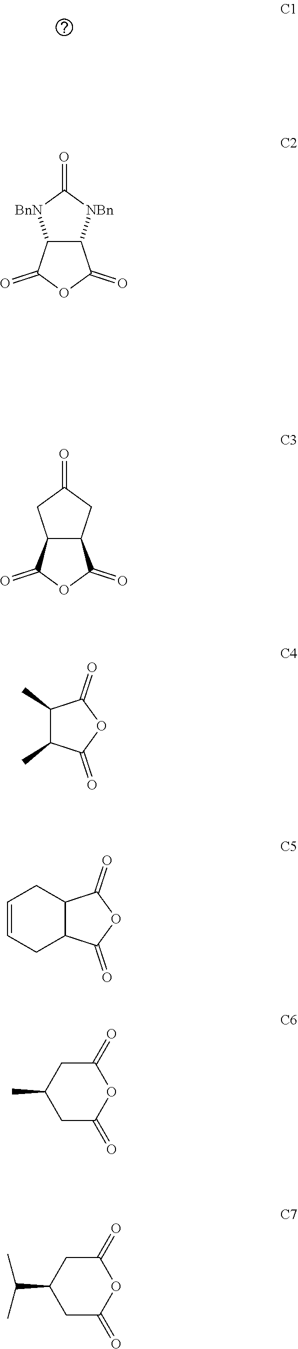 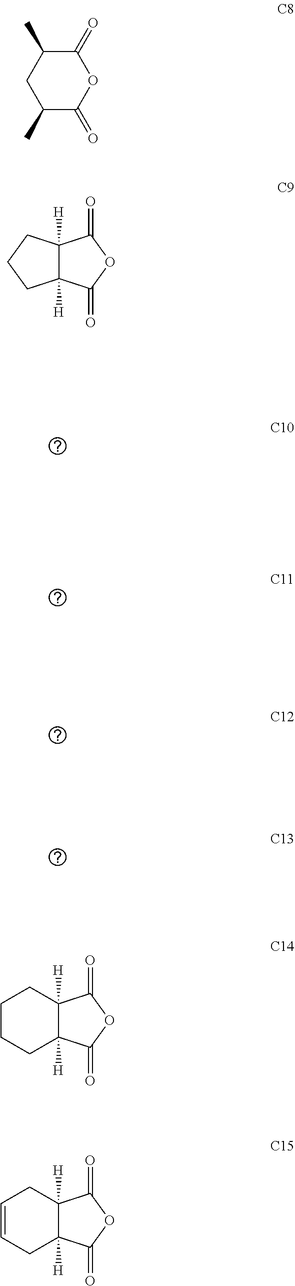 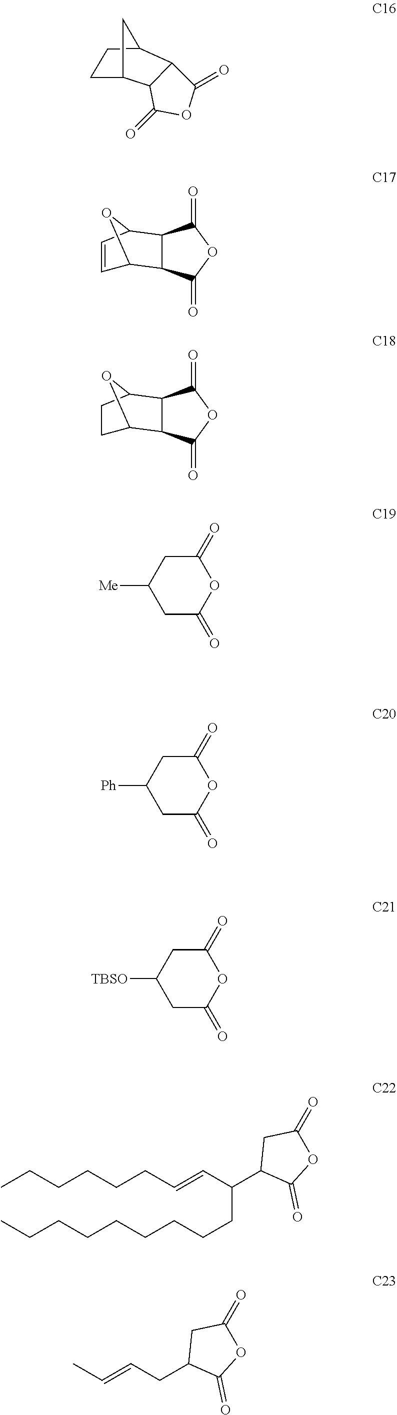 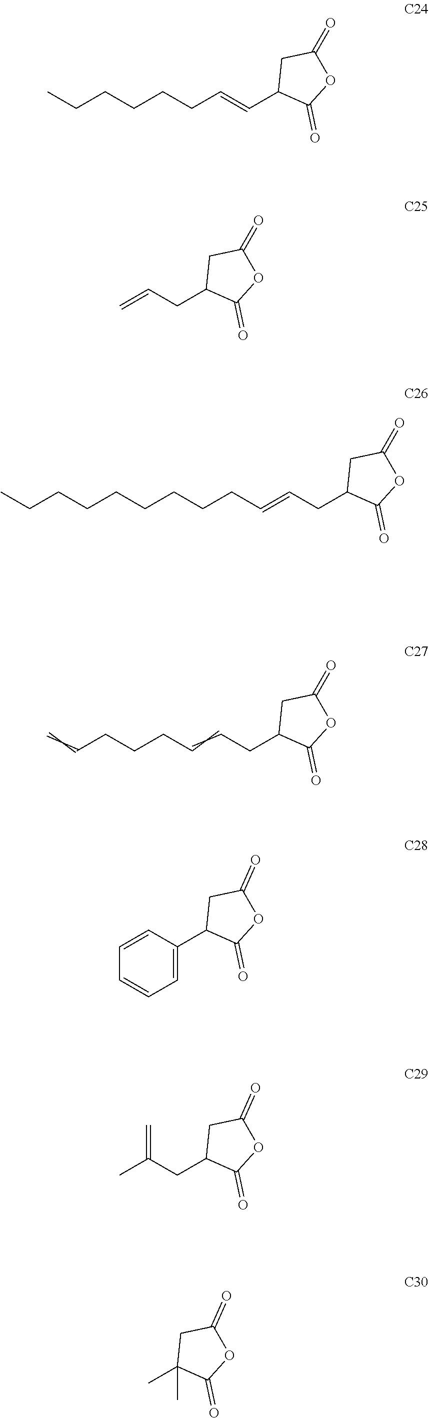 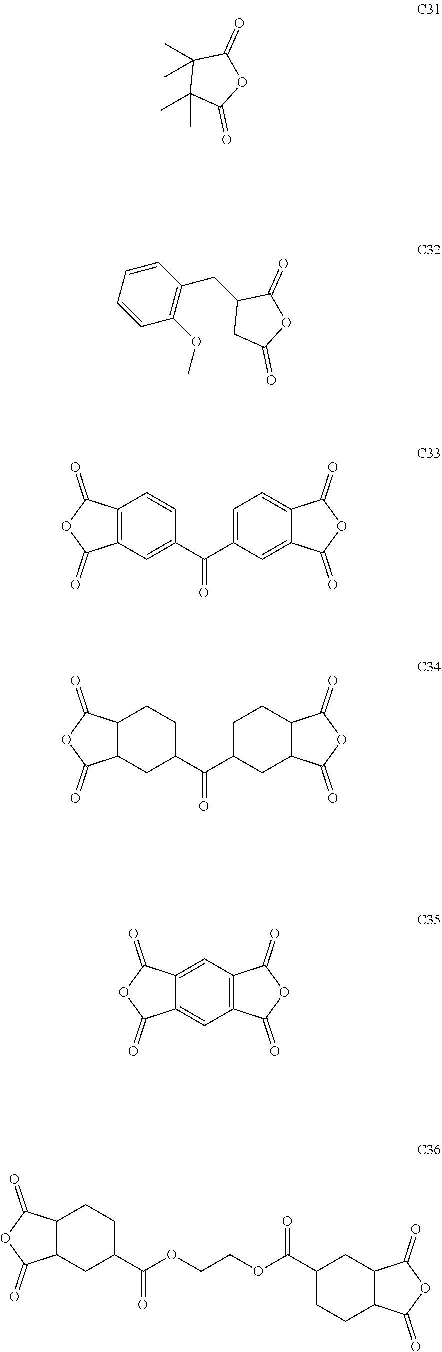 [SMILES: CC1(C)C(=O)OC(=O)C1(C)C ; COc1ccccc1CC1CC(=O)OC1=O ; O=C(c1ccc2c(c1)C(=O)OC2=O)c1ccc2c(c1)C(=O)OC2=O ; O=C(C1CCC2C(=O)OC(=O)C2C1)C1CCC2C(=O)OC(=O)C2C1 ; O=c1oc(=O)c2cc3c(=O)oc(=O)c3cc12 ; O=C(OCCOC(=O)C1CCC2C(=O)OC(=O)C2C1)C1CCC2C(=O)OC(=O)C2C1] 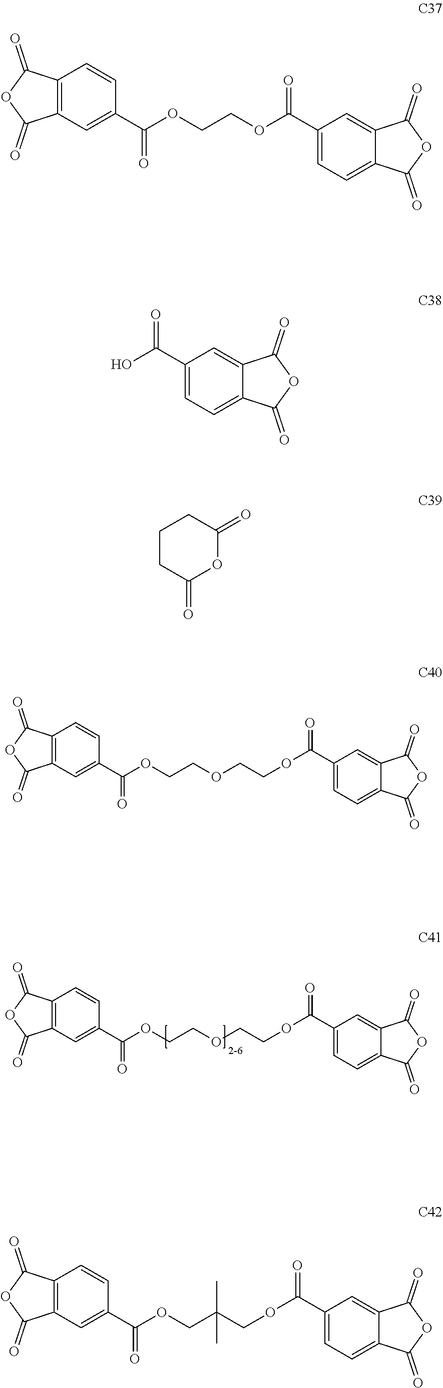
and a mixture of two or more thereof.

6. The polymer (D) according to claim 1, wherein the at least one compound of formula (I) is 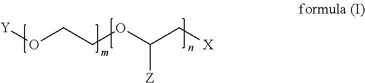
wherein X is selected from the group consisting of hydrogen, C₁-C₁₈ alkyl, C₂-C₁₈ alkenyl and C₇ to C₁₅ arylalkyl;
Z is independently selected from the group consisting of —CH₃, —C₂H₂, —C₃H₇, and —C₆H₆,
m is in a range of from 5 to 100,
n is in a range of from 0 to 20,
X is selected from the group consisting of —OC(O)—R—C(O)OH, —NHC(O)—R—C(O)OH and —ORC(O)OH; wherein
R is selected from the group consisting of C₁-C₁₀ alkyl, C₂-C₁₀ alkenyl, C₆-C₁₀ cycloaliphatic and C₆ aromatic,
R¹ is selected from the group consisting of hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, and substituted or unsubstituted C₆-C₁₀ aryl.

7. The polymer (D) according to claim 1, wherein the compound of formula (I) is a random copolymer or a block copolymer and comprises at least 50 wt. % of ethylene oxide in polymerized form based on overall weight of compound of formula (I).

8. The polymer (D) according to claim 7, wherein the compound of formula (I) is a random copolymer or a block copolymer and comprises ethylene oxide in a range of from 50 to 100 wt. % and propylene oxide in a range of from 0 to 50 wt. %, each based on overall weight of compound of formula (I).

9. The polymer (D) according to claim 1, wherein the polymer has a number average molecular weight in a range of from 2000 to 100000 g/mol as measured using GPC using THE or chloroform as solvent.

10. A process for the preparation of a polymer (D) comprising the steps of:
a. providing at least one epoxide (E) having an average functionality of ≥3.0 and a number average molar weight in a range of from 250 to 25000 g/mol as determined according to GPC using THE as solvent;
b. providing at least one compound of formula (I) 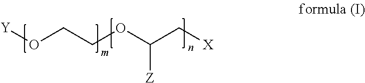
wherein Y is selected from the group consisting of hydrogen, linear or branched, substituted or unsubstituted C₁-C₃₀ alkyl, linear or branched, substituted or unsubstituted C₂-C₃₀ alkenyl or substituted or unsubstituted C₆-C₁₀ cycloalkyl, substituted or unsubstituted C₇ to C₁₅ arylalkyl, substituted or unsubstituted C₆-C₁₀ arylalkyl and substituted or unsubstituted C₆-C₁₀ aryl,
Z is selected from the group consisting of C₁-C₆ alkyl and C₆-C₁₀ aryl,
m is in a range of from 5 to 500,
n is in a range of from 0 to 100,
X is selected from the group consisting of —OC(O)—R—C(O)OH, —NR¹C(O)—R—C(O)OH, —ORC(O)OH, —OC(O)—R—SH, —NHR¹ and —O—R—SH;
wherein R is selected from the group consisting of linear or branched, substituted or unsubstituted C₁-C₁₀ alkylene, linear or branched, substituted or unsubstituted C₂-C₁₀ alkenylene, substituted or unsubstituted C₆-C₁₀ cycloalkylene, and substituted or unsubstituted C₆-C₁₀ arylene, and
R¹ is selected from the group consisting of hydrogen, linear or branched, substituted or unsubstituted C₁-C₁₀ alkyl, linear or branched, substituted or unsubstituted C₂-C₁₀ alkenyl, substituted or unsubstituted C₆-C₁₀ cycloalkyl, substituted or unsubstituted C₆-C₁₀ aryl, and substituted or unsubstituted C₆-C₁₀ arylalkyl to obtain a mixture:
c. providing at least one compound (P) having at least one pigment affinic group has at least one active hydrogen to obtain a ternary mixture, and
d. heating the mixture obtained in step c. to a desired temperature to obtain the product polymer (D).

11. A method of using a polymer (D) according to claim 1, the method comprising using the polymer (D) as a dispersant for particulate solid material.

12. The method according to claim 11, wherein the particulate solid material comprises pigments.

13. A composition in the form of a dispersion comprising,
a. the polymer (D) according to claim 1;
b. at least one particulate solid material selected from the group consisting of pigments and fillers,
c. at least one liquid diluent, and
d. at least one polymeric binder,
wherein the particulate solid material is dispersed in a liquid diluent selected from the group consisting of organic solvents, water, and mixtures thereof.

14. The composition according to claim 13, comprising
a) ≥1 to ≤70% by weight, based on the total weight of the composition, particulate solid material selected from the group consisting of pigments and fillers;
b) ≥0.5 to ≤50% by weight, based on the total weight of the composition, of the polymer (D); and
c) ≥10 to ≤98.5% by weight, based on the total weight of the composition, liquid diluent.

15. The composition according to claim 14 having a particle size (D₅₀) in a range of from 10 to 500 nm measured using dynamic light scattering technique.
